(19) United States
(12) Patent Application Publication
(10) Pub. No.: US 2026/0289262 A1
(43) Pub. Date: Sep. 24, 2026

(54) SYSTEM

(71) Applicant: SoftBank Group Corp., Tokyo (JP)

(72) Inventor: Tetsuya YOSHIMURA, Tokyo (JP)

(73) Assignee: SoftBank Group Corp., Tokyo (JP)

(21) Appl. No.: 19/564,346

(22) Filed: Mar. 12, 2026

(30) Foreign Application Priority Data
Mar. 19, 2025 (JP) 2025-044928

(51) Int. Cl. G06N 3/0475; G06N 3/0499

(52) U.S. Cl. CPC G06N 3/0475; G06N 3/0499

(57) ABSTRACT

A system includes a processor, in which the processor is configured to: collect information related to past crimes and obtain the information from a database; preprocess the collected information and convert the preprocessed information into numerical vectors by using a natural language processing technique; and input a prompt to a generative AI model in order to instruct the generative AI model to extract features related to crimes.

### CROSS-REFERENCE TO RELATED APPLICATION

This application is based on and claims priority under 35 USC 119 from Japanese Patent Application No. 2025-044928 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional crime detection systems that analyze text information typically rely on static rule sets, manually defined keyword lists, or discriminator-type machine learning models trained on fixed feature spaces. The server in such systems often cannot flexibly adapt to newly emerging crime patterns, such as novel fraud schemes or evolving terrorism-related communications, because the feature extraction logic is predefined and requires manual updating. The processor in these conventional systems also tends to treat the feature extraction process and the downstream analysis process as separate, rigid components, which limits the system's ability to generate contextually rich representations of crime-related information. As a result, the system often fails to capture subtle linguistic cues or complex relationships in text data, leading to low detection accuracy, delayed response to new crime trends, and an increased burden on human operators to maintain and update rules.

Furthermore, conventional systems generally do not utilize generative AI models as active participants in the construction of crime-related features. The processor in such systems typically does not input prompts to generative AI models in a structured manner to instruct the extraction of crime-related features, nor does it use prompts generated by the generative AI model itself to refine subsequent analysis or warning logic. Accordingly, the system cannot effectively leverage the generative AI model's capability to create adaptive prompts and feature representations in response to new analysis results. This limitation makes it difficult to automatically issue accurate warnings before transmission of potentially crime-related information or to reliably identify information associated with crimes such as fraud and terrorism. Therefore, there is a need for a system that can systematically collect and preprocess past crime-related information, convert such information into numerical vectors by natural language processing techniques, and cooperate with a generative AI model via prompts to extract and utilize crime-related features for improved detection, warning, and identification.

### SUMMARY

In order to solve the above-described problems, a system according to one aspect of the present invention comprises a processor, wherein the processor is configured to collect information related to past crimes and obtain the information from a database. The processor is further configured to preprocess the collected information and convert the preprocessed information into numerical vectors by using a natural language processing technique. The processor is additionally configured to input a prompt to a generative AI model in order to instruct the generative AI model to extract features related to crimes. By doing so, the processor allows the system to construct a feature space that reflects patterns present in past crime-related texts, while continuously leveraging the generative capabilities of the AI model through explicit prompting.

In one embodiment, the processor is configured to use a prompt generated by the generative AI model, based on an analysis result computed from the numerical vectors and extracted features, to issue a warning before transmission of specific information. The processor thereby enables the system to utilize dynamically generated prompts as part of a feedback loop between the analysis result and the warning logic, so that the system can automatically present pre-transmission alerts when outgoing content exhibits characteristics similar to known crime-related patterns.

In another embodiment, the processor is configured to use a prompt generated by the generative AI model, based on an analysis result, to identify information related to crimes including fraud and terrorism. The processor thereby enables the system to refine classification or tagging of information as crime-related by using generative prompts that are tailored to the current analysis context. Through these configurations, the system according to the present invention can flexibly and adaptively extract crime-related features, issue appropriate warnings prior to transmission, and accurately identify information associated with crimes, thus overcoming the limitations of conventional static rule-based or fixed-feature detection systems.

The term “processor” refers to one or more hardware computing units, such as a central processing unit (CPU), a graphics processing unit (GPU), a digital signal processor (DSP), or any combination thereof, that executes instructions to perform the functions described in the claims.

The term “system” refers to an arrangement comprising at least the processor and one or more associated memories or storage devices, communication interfaces, and software components, which cooperatively perform the collection, preprocessing, analysis, and handling of crime-related information as described in the claims.

The term “information related to past crimes” refers to data associated with criminal activities that have occurred in the past, including but not limited to message texts, communication logs, account identifiers, metadata, case records, and annotations indicating whether the information is crime-related.

The term “database” refers to any structured data storage facility, including relational databases, NoSQL databases, data warehouses, or other persistent storage systems, from which the processor can retrieve information related to past crimes.

The term “preprocess” refers to operations performed by the processor on raw information related to past crimes to normalize, clean, segment, or otherwise transform the information into a form suitable for analysis, including operations such as tokenization, lowercasing, removal of noise, and normalization of characters or formats.

The term “natural language processing technique” refers to any computational method applied to human language data, including but not limited to tokenization, part-of-speech tagging, word or sentence embedding, vectorization methods such as TF-IDF, and neural language model techniques, which enable the processor to convert text into numerical representations.

The term “numerical vectors” refers to data structures comprising one or more numerical values, such as arrays or tensors, that quantitatively represent characteristics of textual information so that the information can be processed by machine learning or statistical models.

The term “generative AI model” refers to a machine learning model that is capable of generating outputs such as text, prompts, or feature descriptions in response to input data or prompts, including but not limited to large language models, transformer-based models, and other generative neural network architectures.

The term “prompt” refers to textual or structured input data provided to the generative AI model to instruct the generative AI model to perform a specified operation, such as extracting crime-related features, generating analysis guidance, or producing further prompts.

The term “features related to crimes” refers to abstracted characteristics, attributes, or patterns derived from information related to past crimes, including linguistic patterns, statistical indicators, semantic cues, and other representations that are useful for detecting, classifying, or identifying crime-related information.

The term “analysis result” refers to output generated by the system based on the numerical vectors and the features related to crimes, including but not limited to risk scores, classification labels, similarity measures, or other indicators used to evaluate whether specific information is likely to be crime-related.

The term “specific information” refers to information, such as a message, communication content, or data item, that is a candidate for transmission and that is subject to analysis by the system to determine whether a warning or blocking action should be taken.

The term “warning” refers to a notification generated by the system to alert a user or another component that specific information to be transmitted may be related to a crime, and that additional attention, review, or action may be necessary before transmission.

The term “transmission” refers to the act of sending specific information from the system to an external destination, such as a recipient device, a communication network, or another system, by means of electronic communication.

The term “identify information related to crimes” refers to the act of determining, classifying, or tagging that particular information is associated with criminal activity, such as fraud or terrorism, based on the analysis result and the use of prompts generated by the generative AI model.

The term “fraud” refers to deceptive activities aimed at unlawfully obtaining money, property, or other benefits, including but not limited to financial scams, phishing schemes, and misrepresentation for personal gain.

The term “terrorism” refers to activities that involve or are related to the use of violence, threats, or intimidation against persons or property for political, ideological, or religious purposes, including communications that support, promote, or facilitate such activities.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

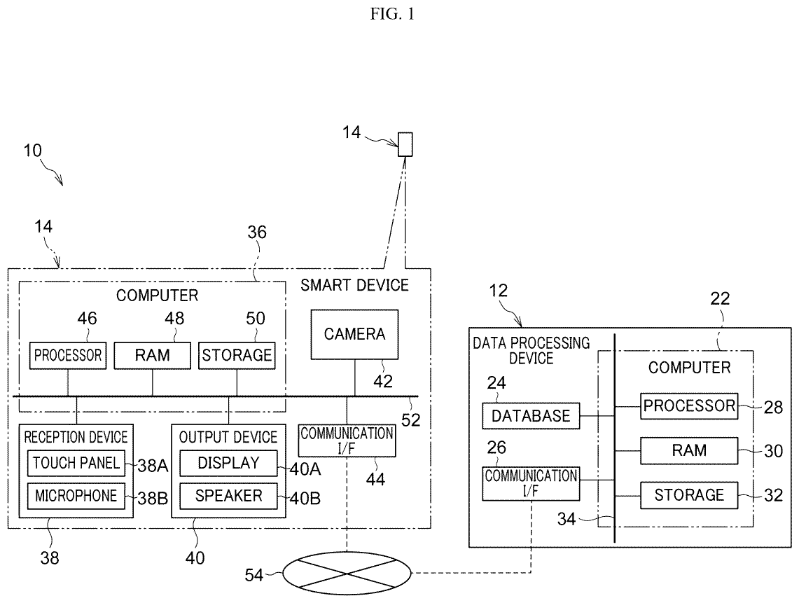

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

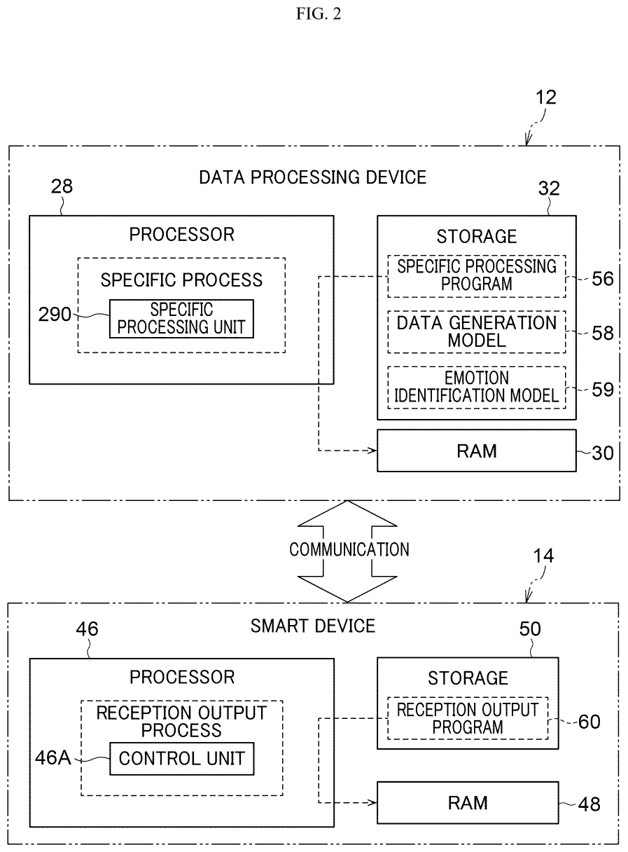

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional crime-related information analysis systems generally rely on static rule sets, manually designed keyword lists, or fixed classification models. Such systems typically operate in a pipeline where historical text data is ingested, preprocessed, and classified by a predictive model. However, these systems suffer from several technical limitations in terms of computer technology.

First, existing systems do not tightly integrate user-specified analysis instructions, expressed as natural-language prompt sentences, with the internal feature representations and outputs of predictive models. As a result, when a user requests a specific type of analysis (for example, focusing on a particular type of suspicious behavior or a particular time window), the system often executes rigid, pre-defined queries or workflows, which are not dynamically adapted to the intent contained in the user's prompt. This leads to inefficient use of computational resources, because the system may perform unnecessary processing or retrieve irrelevant data, and it also reduces the relevance and interpretability of the generated results.

Second, in many conventional architectures, the explanatory text or advisory output provided to the user is either handcrafted or loosely coupled to the underlying numerical feature data and model outputs. Even when a generative AI model is used, it is often invoked as a separate component that receives raw or unstructured input, without being grounded in the structured feature information produced by the predictive model. This separation reduces the ability of the computer system to generate explanations that are both context-aware and aligned with the internal state of the machine-learned model. Consequently, users receive explanations that may be vague, inconsistent with the model's actual decision process, or difficult to use for downstream automated actions such as alert generation.

Third, existing systems are not designed to systematically transform model outputs and feature vectors into structured analysis targets, and then feed those structured analysis targets into a generative AI model in a manner that is directly controlled by the user's prompt sentence. Without such a structured and prompt-driven integration, the system cannot efficiently focus computation on the most relevant accounts, messages, or events, and cannot reliably produce targeted alerts or guidance prior to the transmission of potentially harmful information. This results in suboptimal utilization of processor, memory, and network resources, and limits the scalability and responsiveness of the system when processing large volumes of text data. Accordingly, there is a need for an improved computer-implemented system that: (i) converts historical text data into numerical feature data for predictive modeling, (ii) dynamically interprets user prompt sentences to determine analysis intent, (iii) selects and structures predictive model outputs as analysis targets in accordance with the interpreted intent, and (iv) uses a generative AI model, driven by both the prompt sentence and the structured analysis targets, to generate context-grounded explanatory or advisory results. Such a system would improve the technical functioning of the computer by enabling more efficient data selection, better alignment between model internals and generated explanations, and more effective generation of alert information or behavior-related identifications in real time.

The specific processing by the specific processing unit 290 of the data processing device 12 in Example 1 is realized by the following means.

The present invention provides a server comprising a processor and a storage device, the processor being configured to acquire past behavior-related text data from the storage device, perform preprocessing including at least normalization, removal of unnecessary elements, and segmentation on the text data, convert the preprocessed text data into numerical feature data by using a natural language processing technique, train a prediction information processing model by using a machine learning framework based on the numerical feature data and associated identification information, acquire new text data, apply the preprocessing and numerical conversion to the new text data, input resulting numerical feature data to the prediction information processing model to extract feature information indicating degrees of behavior relevance, receive a prompt sentence from a user terminal, analyze the prompt sentence to determine an analysis intent, select, based on the analysis intent, at least part of the feature information and outputs of the prediction information processing model as analysis targets, generate structured information representing the analysis targets, generate an input sentence for a generative information processing model based on the prompt sentence and the structured information, input the input sentence to the generative information processing model to obtain a generation result including explanatory text or advisory information, and output, to the user terminal, an analysis result including the generation result and the feature information. This enables the computer system to dynamically align internal model features and outputs with user-specified analysis intents, to efficiently focus processing on relevant behavior-related data, and to generate context-grounded explanatory and advisory content that can be directly used for real-time alerting and identification of behavior-related information, thereby improving the overall technical performance and practical utility of the crime-related information analysis system.

The term “past behavior-related information” refers to information stored in a storage device that is associated with historical events or actions, including but not limited to text data such as messages, logs, or records that describe, indicate, or are otherwise linked to past behaviors.

The term “text data” refers to information represented as character strings, including natural-language sentences, phrases, or tokens, which may be stored in one or more data records and processed by the system.

The term “storage device” refers to a hardware component or a combination of hardware components configured to store data, such as a magnetic disk, a solid-state drive, a semiconductor memory, or any other non-transitory computer-readable recording medium.

The term “working memory” refers to a memory resource, such as a volatile semiconductor memory, that temporarily stores data and intermediate results used by a processor during execution of processing steps.

The term “preprocessing” refers to a series of operations performed on raw text data to convert the text data into a form suitable for further analysis, including at least character string normalization, removal of unnecessary elements, and segmentation of the text into linguistic units.

The term “character string normalization” refers to processing that standardizes representations of characters or strings, such as converting characters to a common case, unifying encodings, or normalizing variant forms of characters.

The term “removal of unnecessary elements” refers to processing that removes data items that do not contribute to the intended analysis, such as markup symbols, control characters, certain punctuation, or other extraneous tokens.

The term “segmentation of the text data into linguistic units” refers to dividing text data into smaller analysis units, such as words, subwords, or sentences, which can be used as input for subsequent linguistic or numerical processing.

The term “natural language processing technique” refers to a computational method or algorithm that processes and analyzes human language data, including tokenization, parsing, embedding, or other operations that allow a computer to interpret and represent natural-language text.

The term “numerical feature data” refers to data expressed as numerical values, such as vectors or tensors, that represent properties or characteristics of the original text data in a form suitable for input to a machine learning model.

The term “machine learning framework” refers to a software environment or library that provides functions for constructing, training, and evaluating machine learning models, including support for numerical computation, gradient-based optimization, and model serialization.

The term “prediction information processing model” refers to a machine-learned model configured to receive numerical feature data as input and to output information indicating predictions, classifications, or scores related to behavior relevance or other analysis targets.

The term “identification information” refers to data associated with the past behavior-related information that indicates a category, label, or attribute, such as whether the information is associated with fraudulent behavior, legitimate behavior, or other types of events.

The term “training” refers to a process in which parameters of a prediction information processing model are adjusted based on input data and corresponding identification information, typically through iterative optimization that reduces a loss function.

The term “new text data” refers to text data that is acquired after the training of the prediction information processing model, and that is subjected to preprocessing and analysis by the trained model for inference purposes.

The term “feature information” refers to information derived from the prediction information processing model, including scores, probabilities, or intermediate feature representations that indicate degrees of relevance between the input data and one or more behaviors or categories.

The term “degree of relevance” refers to a value or set of values, such as a probability, score, or weight, that quantitatively indicates how strongly an item of text data is associated with a particular behavior or category.

The term “user terminal” refers to an information processing apparatus operated by a user, such as a personal computer, a tablet, a smartphone, or any other client device capable of communicating with the server over a network.

The term “prompt sentence” refers to a natural-language text input provided by a user via the user terminal, which expresses an analysis request, an instruction, or an inquiry to be processed by the system.

The term “analysis intent” refers to an interpretation of the semantic content of a prompt sentence, including at least a type of target behavior, an analysis scope, or other parameters that specify how the system should carry out an analysis.

The term “analysis target” refers to at least one data item, such as an account, message, event, or record, that is selected based on feature information and model outputs in accordance with the analysis intent to be the subject of further analysis.

The term “structured information” refers to information organized according to a predefined schema or format, such as a list, table, or hierarchical structure, including identifiers of analysis targets, corresponding feature information, and corresponding model outputs.

The term “generative information processing model” refers to a machine-learned model, such as a generative language model, that receives an input sentence and generates new text, including explanatory text or advisory information, according to learned patterns.

The term “input sentence for a generative information processing model” refers to a composed natural-language text that includes at least a prompt sentence and structured information and that is provided as input to the generative information processing model to cause it to produce a generation result.

The term “generation result” refers to one or more outputs produced by the generative information processing model in response to the input sentence, including at least explanatory text, advisory information, or other generated natural-language content.

The term “explanatory text” refers to generated natural-language content that explains, describes, or interprets feature information, model outputs, or behaviors associated with analysis targets.

The term “advisory information” refers to generated natural-language content that recommends, suggests, or indicates actions, countermeasures, or policies to be taken based on the analysis of behavior-related information.

The term “analysis result” refers to information output to the user terminal that includes at least a generation result and associated feature information, and that presents the outcome of the system's analysis in a form understandable by the user.

The term “alert information” refers to information generated by the processor to warn or notify a user, prior to transmission of specific information to an external destination, that the information may be associated with a risky or undesirable behavior.

The term “fraudulent conduct” refers to behavior involving deception or misrepresentation for the purpose of obtaining an unfair or unlawful advantage, as reflected in the text data or associated records analyzed by the system.

The term “harmful conduct” refers to behavior that may cause damage or risk, including but not limited to attacks, abuses, or other actions that are undesirable or dangerous within the context of the analyzed information.

In one embodiment, a server implements the claimed system by executing a computer program on one or more processors and cooperating with one or more storage devices and user terminals connected via a communication network.

The server includes at least a central processing unit (CPU), a main memory, a non-transitory storage device, and a network interface. The server uses, for example, a multi-core general-purpose CPU and optionally a graphics processing unit (GPU) for acceleration of numerical computation. The storage device includes, for example, a solid-state drive or magnetic disk configured to store a relational database, model parameters, and log data. The main memory stores program instructions and data structures used during execution.

The server executes an operating system and one or more application programs written in a high-level language. The server uses a database management system, such as a relational database engine, to store past behavior-related information. The server also uses software libraries implementing natural language processing, such as tokenizers and embedding generators, and machine learning frameworks, such as a deep learning library, to implement a prediction information processing model and a generative AI model interface.

The server acquires past behavior-related text data, such as message records, transaction logs, or communication logs, from the storage device. The server uses a database query engine to access tables that contain text fields, timestamp fields, and label fields indicating categories such as fraudulent conduct or legitimate conduct. The server stores the acquired records in working memory and represents each record as a structured object containing, for example, a text string, an identifier, and a label.

The server performs preprocessing on the text strings to convert them into numerical feature data. The server normalizes character strings by converting text to a uniform character set, unifying case, and normalizing punctuation. The server removes unnecessary elements, such as markup tags, control characters, and tokens that are irrelevant to behavior analysis. The server segments the text into linguistic units by applying a tokenizer that splits the text into words or subword units. The server optionally applies lemmatization or stemming to reduce word variants to base forms. The server converts the sequence of tokens into numerical vectors by using an embedding model. For example, the server uses a transformer-based encoder to map a token sequence to a high-dimensional vector, such as a 768-dimensional floating-point vector. The server stores these numerical vectors in a feature store, which may be a dedicated table in the database or an in-memory data structure optimized for vector access.

The server trains a prediction information processing model by using a machine learning framework. In one embodiment, the server implements the prediction information processing model as a feed-forward neural network having an input layer corresponding to the dimension of the numerical feature data, one or more hidden layers with non-linear activation functions, and an output layer that outputs a probability distribution over behavior categories. The server initializes the model parameters, such as weight matrices and bias vectors, and selects a loss function, such as cross-entropy loss for classification. The server uses an optimization algorithm, such as stochastic gradient descent with momentum or an adaptive gradient method, to update the parameters.

The server divides the historical numerical feature data and associated identification information into training and validation subsets. The server repeatedly inputs mini-batches of numerical feature vectors and labels into the model, computes forward passes to obtain predicted probabilities, computes the loss function, and computes gradients of the loss with respect to the model parameters by backpropagation. The server updates the parameters according to the gradients and a learning rate. The server performs this process for multiple epochs and monitors validation metrics such as accuracy, precision, recall, and F1 score. The server stores the trained model parameters in the storage device when the validation metrics reach a satisfactory level.

The server thereby improves computer technology by optimizing the internal numerical representation of text data and the mapping from that representation to behavior relevance scores. The server uses vectorized linear algebra operations and batch processing on the CPU and optionally GPU, thereby reducing processing time compared to rule-based or purely symbolic systems. The server's use of dense numerical feature vectors reduces memory footprint and allows efficient indexing and retrieval, which improves data management and computational efficiency.

The server acquires new text data from the storage device or from external systems via the network interface. The server applies the same preprocessing pipeline used during training to the new text data to generate numerical feature data that are aligned with the trained model's input space. The server inputs the resulting vectors to the prediction information processing model and obtains outputs such as probabilities that the text data corresponds to certain behaviors. The server interprets these outputs as feature information, such as behavior relevance scores, that quantify how strongly each text record is associated with fraud, harmful conduct, or other categories.

The server aggregates feature information on a per-entity basis, such as per account, per communication channel, or per device identifier. The server computes aggregated metrics such as average relevance scores, maximum scores over a time window, or anomaly measures derived from statistical distributions. The server stores these aggregated metrics as structured records in the database, thereby creating an efficient data structure for later analysis. This aggregation reduces the volume of data that must be processed by subsequent components and decreases the load on the network when transmitting analysis results.

The user operates a terminal, such as a personal computer, smartphone, or tablet, which executes a client application or web browser. The terminal displays an input field for a prompt sentence. The user inputs a natural-language prompt sentence that specifies an analysis request. For example, the user may input:

“Based on the latest transaction messages and login history, identify accounts that are likely to be involved in phishing, and explain the reasons.”

or

“Summarize the most common fraud patterns detected in the last 24 hours and suggest preventive rules that could be added to our monitoring system.”

The terminal transmits the prompt sentence to the server via a communication protocol. The server receives the prompt sentence and analyzes it using natural language processing. The server tokenizes the prompt sentence, identifies key terms indicating behavior types (for example, “phishing” or “fraud”), and identifies requested operations, such as “identify accounts,” “summarize patterns,” or “suggest preventive rules.” The server thus determines an analysis intent that includes at least a behavior type and a scope, such as a period or a set of entities.

The server uses the analysis intent to select analysis targets. The server queries the feature information and model outputs to identify records that match the behavior type and exceed a threshold relevance score. The server may rank entities by their relevance scores and select a predetermined number of top-ranked entities. The server structures the selected analysis targets into a data structure that includes identifiers (such as account identifiers), corresponding relevance scores, representative messages, timestamps, and any additional features such as IP address statistics. The server represents this structural information as a list or table in working memory.

The server generates an input sentence for a generative AI model by combining the user's prompt sentence and the structured information. The server converts the structured information into a human-readable description, such as a list of accounts and their associated messages and scores, and appends this description to the prompt sentence. The server explicitly instructs the generative AI model to perform specific tasks, such as explaining why certain accounts are high-risk, summarizing patterns across messages, or proposing detection rules. By constructing the input sentence in this manner, the server constrains the generative AI model to operate over a set of analysis targets determined by the prediction information processing model, rather than generating free-form content without grounding.

The server transmits the input sentence to a generative AI model. In one embodiment, the generative AI model is a transformer-based language model hosted on the same server or on a separate inference server. The generative AI model comprises multiple layers of self-attention and feed-forward networks, with parameters stored in the storage device and loaded into memory at inference time. The generative AI model receives the tokenized input sentence, computes contextual embeddings via multi-head self-attention, and generates output tokens sequentially according to a probability distribution conditioned on the input. The generative AI model's text generation is thus guided both by the original prompt sentence and the structured feature information.

The server receives the output of the generative AI model as a generation result. The generation result includes explanatory text, such as reasons why specific accounts are likely to be involved in phishing, and advisory information, such as recommended monitoring rules or thresholds. The server optionally post-processes the generation result by segmenting it into sections, checking it against policies, and truncating it to a specified length. The server combines the generation result with the original feature information, including numerical scores and identifiers, to form an analysis result.

The server outputs the analysis result to the terminal. The terminal displays the analysis result in a user interface, such as a dashboard showing a ranked list of accounts with their relevance scores and an accompanying explanation describing the patterns detected. The user reads the explanation and can issue follow-up commands, such as marking an account for review, adjusting thresholds, or requesting a new analysis via another prompt sentence.

The server thus improves computer technology by integrating the prediction information processing model and the generative AI model in a structured, prompt-driven manner. Because the server uses internally computed feature information and model outputs to constrain and inform the generative AI model, the server reduces the search space over which the generative AI model must operate. This reduces computation time and memory usage in the generative AI model and increases the relevance of the generated explanations. The server also reduces network communication, because the server sends only summarized and structured analysis results to the terminal instead of transmitting raw logs or large volumes of unfiltered data.

The server's processing is not a mere automation of human mental analysis. The server uses high-dimensional numerical feature vectors, gradient-based optimization, and transformer attention mechanisms that are not practicable in human cognition. The server applies non-intuitive selection and aggregation rules based on statistical thresholds and learned weights in the model, rather than simple keyword matching or fixed heuristics. For example, the server may detect a combination of rare tokens and temporal patterns that correlate with fraudulent conduct, which a human analyst would not easily derive. The server's algorithmic flow, including the use of mini-batch optimization, regularization, and early stopping, is specifically designed to optimize computational performance and generalization accuracy.

In one variation, the server uses a different neural network architecture for the prediction information processing model, such as a recurrent network or a convolutional network, while still converting text to numerical feature vectors. In another variation, the server uses a vector database to store numerical feature data and performs approximate nearest-neighbor search to rapidly retrieve similar patterns when constructing structured information. In yet another variation, the server employs model compression techniques, such as quantization or pruning, to reduce memory usage and increase inference speed, thereby further improving technical performance.

The terminal can be implemented on various hardware platforms and operating systems. The terminal includes a display, input devices, and a communication module. The terminal does not perform heavy numerical computation; instead, the terminal delegates intensive processing to the server. This division of labor improves overall system efficiency by centralizing heavy computation in the server, which can be equipped with specialized hardware such as GPUs, while keeping the terminal implementation lightweight.

The user interacts with the system by providing prompt sentences and interpreting analysis results. The user does not need to manage model training, data preprocessing, or resource allocation. The server automatically manages these technical aspects and maintains consistency between training and inference pipelines, thus reducing configuration errors and improving reliability.

In summary, the server executes a series of concrete technical operations, including structured data retrieval, numerical feature vector computation, neural network training and inference, intent parsing, structured target selection, and constrained generative text generation. These operations cooperate to enhance the speed, accuracy, and interpretability of behavior-related analysis. The server's processing architecture, data structures, and algorithmic choices provide specific technical effects in terms of improved computational efficiency, reduced memory and communication overhead, and enhanced quality of generated explanations, thereby constituting an improvement in computer technology rather than an abstract idea.

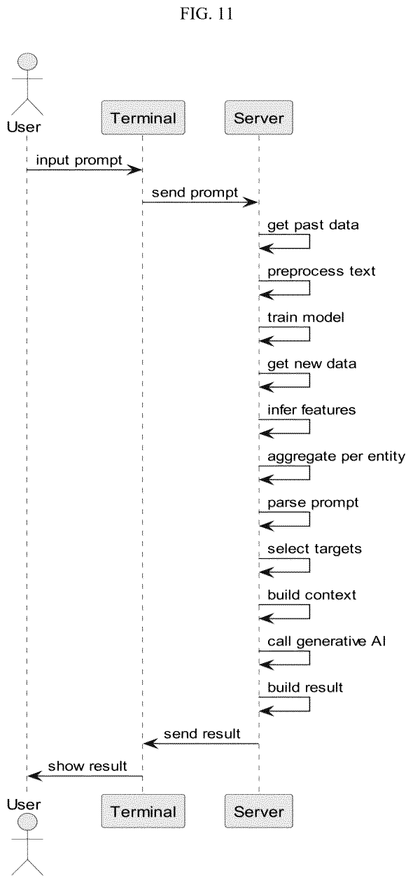

The following describes the processing flow using FIG. 11.
Step 1:

The server acquires past behavior-related text data from a storage device.

The server uses a database engine to execute queries that read records containing text fields, identifiers, timestamps, and labels indicating behavior categories.

Input: raw records stored in one or more database tables.

Processing: the server loads the records into working memory, converts each record into an internal data structure (for example, an object containing a text string, an identifier, and a label), and discards fields that are not needed for analysis.

Output: a collection of structured records containing text data and associated identification information.
Step 2:

The server preprocesses the acquired text data and converts it into numerical feature data.

The server applies character normalization, removal of unnecessary elements, and segmentation into tokens using a natural language processing library.

Input: structured records containing text strings.

Processing: the server lowercases text, normalizes character encodings, removes markup and control symbols, segments text into tokens, optionally lemmatizes words, and maps tokens to numeric vectors using an embedding model or encoder network.

Output: a set of numerical feature vectors, each associated with an identifier and a label.
Step 3:

The server trains a prediction information processing model based on the numerical feature data and identification information.

The server uses a machine learning framework to construct a neural network classifier and adjust its parameters.

Input: numerical feature vectors and corresponding labels.

Processing: the server splits the data into training and validation sets, feeds mini-batches of feature vectors into the model, computes predicted probabilities, calculates a loss value using a loss function, performs backpropagation to obtain gradients, and updates model parameters using an optimization algorithm over multiple epochs.

Output: trained model parameters stored as a prediction information processing model ready for inference.
Step 4:

The server acquires new text data for analysis and converts it into numerical feature data.

The server obtains new records from the storage device or from external sources through the network interface.

Input: newly stored or streamed records containing text fields and identifiers.

Processing: the server applies the same preprocessing pipeline used in training, including normalization, tokenization, and embedding, to generate numerical feature vectors that are compatible with the trained model's input format.

Output: a set of numerical feature vectors corresponding to new text data, each linked to an identifier.
Step 5:

The server infers feature information from the new numerical feature data using the trained prediction information processing model.

The server loads the trained model into memory and executes forward passes for the new inputs.

Input: numerical feature vectors for new text data and the trained model parameters.

Processing: the server performs matrix multiplications and activation functions layer by layer to compute output scores or probabilities indicating degrees of relevance to one or more behavior categories.

Output: feature information, including behavior relevance scores and optionally intermediate feature representations, associated with each identifier.
Step 6:

The server aggregates feature information per analysis entity.

The server groups records by entity, such as by account identifier or device identifier.

Input: feature information for individual text records, including relevance scores and identifiers.

Processing: the server computes aggregated metrics for each entity, such as maximum relevance score over a time window, average score, or other statistical measures, and stores these metrics as entity-level feature records.

Output: structured entity-level feature information representing behavior relevance per entity.
Step 7:

The user inputs a prompt sentence through a terminal.

The user interacts with a graphical user interface provided by a client application or web browser.

Input: user's natural-language prompt sentence, such as “Based on the latest transaction messages and login history, identify accounts that are likely to be involved in phishing, and explain the reasons.”

Processing: the terminal captures the text input, packages it with user and session identifiers, and prepares it as a request message.

Output: a request containing the prompt sentence sent from the terminal to the server over a network.
Step 8:

The server analyzes the prompt sentence to determine an analysis intent.

The server uses natural language processing to extract behavior types and requested analysis operations.

Input: prompt sentence and optional user context information.

Processing: the server tokenizes the prompt sentence, identifies key terms indicating target behaviors (for example, “phishing,” “fraud,” or “suspicious accounts”), detects temporal or scope constraints (for example, “last 24 hours”), and maps the sentence to an internal representation describing behavior type, time window, and requested outputs.

Output: an analysis intent object specifying target behavior categories, analysis scope, and required result format.
Step 9:

The server selects analysis targets based on the analysis intent and feature information.

The server queries the stored entity-level feature information and record-level scores.

Input: analysis intent, entity-level feature information, and record-level feature information.

Processing: the server filters entities by behavior type and relevance threshold, ranks entities according to relevance scores, selects a subset of top-ranked entities, and retrieves associated representative text records and timestamps.

Output: a set of selected analysis targets, each including an entity identifier, aggregated scores, and representative text records.
Step 10:

The server generates structured information representing the analysis targets.

The server organizes the selected entities and their features into a machine-readable structure.

Input: selected analysis targets, including identifiers, scores, and text samples.

Processing: the server constructs a structured object, such as a list or table, where each entry includes an entity identifier, one or more relevance scores, example messages, time information, and any auxiliary attributes relevant to the analysis.

Output: structured information describing analysis targets and their associated feature information.
Step 11:

The server constructs an input sentence for a generative AI model using the prompt sentence and the structured information.

The server translates structured data into descriptive text combined with the user's request.

Input: original prompt sentence and structured information of analysis targets.

Processing: the server formats the structured information into natural-language bullet points or paragraphs, appends or embeds this formatted description into the prompt sentence, and adds explicit instructions such as “Explain why these entities are high-risk and summarize common patterns.”

Output: a combined input sentence suitable for providing to a generative AI model.
Step 12:

The server obtains a generation result from a generative AI model.

The server invokes an inference interface to a generative AI model hosted locally or remotely.

Input: combined input sentence for the generative AI model.

Processing: the server tokenizes the input sentence, sends the tokens to the generative AI model, receives generated tokens from the model, and reconstructs them into an output text. The generative AI model performs internal operations such as self-attention and decoding to produce explanatory and advisory content grounded in the provided context.

Output: a generation result containing explanatory text and optionally advisory information related to the analysis targets.
Step 13:

The server composes an analysis result for presentation to the user.

The server merges numerical feature information with the generated natural-language content.

Input: generation result and feature information for the selected analysis targets.

Processing: the server creates a response structure that includes a list of entities with identifiers and relevance scores, aligns each entity with corresponding explanatory portions of the generated text, and organizes the result into sections such as “Summary,” “Detailed Explanations,” and “Recommended Actions.”

Output: a structured analysis result ready to be transmitted to the terminal.
Step 14:

The terminal receives and displays the analysis result to the user.

The terminal parses the response and renders it in a user interface.

Input: structured analysis result transmitted from the server.

Processing: the terminal extracts entity lists, scores, and explanation text, displays them in tables, charts, or text areas, and provides interaction controls such as buttons for viewing details or initiating follow-up actions.

Output: a visual presentation of the analysis result on the terminal display, enabling the user to understand behaviors and take further steps.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computing systems that monitor electronic communications for criminal or fraudulent activity typically rely on fixed rule sets, static keyword lists, or narrowly trained classifiers. Such approaches suffer from several technical limitations in terms of computer technology itself.

First, existing systems often process communication data with ad hoc text filtering and pattern matching, which are not optimized for modern high-dimensional language representations. As a result, the systems perform redundant parsing, repeated tokenization, and inefficient rule evaluations over large data streams, thereby increasing processor load and memory usage and reducing throughput and real-time responsiveness.

Second, in many systems, models for detecting criminal activity are trained offline and are not continuously updated based on actual user interactions or new communication patterns. Feedback information such as user actions (e.g., blocking a sender, ignoring a warning) is rarely captured in a structured way or reused as training signals. Consequently, the detection accuracy degrades over time as adversaries change linguistic patterns, and the computing resources are consumed on outdated decision processes that fail to exploit newly available behavior data.

Third, in typical architectures, the components that generate warnings to users are separate from the components that perform risk scoring. The generation of warning messages is often implemented as fixed templates or simple string concatenations. This separation causes duplication of logic, prevents the system from generating context-aware warnings aligned with the internal risk representation, and can require multiple passes over the same data, resulting in increased latency and unnecessary computation.

Fourth, many existing systems do not structurally integrate the user interface control layer (such as link disabling or interaction gating) with the underlying machine learning risk evaluation. The user interface is frequently updated through client-side scripts or application logic that are loosely coupled to server-side inference. This loose coupling can lead to inconsistent enforcement of restrictions, additional round trips, and complex error handling, thereby consuming extra network and processing resources and impairing real-time protection.

Fifth, conventional systems lack a unified mechanism for using a generative artificial intelligence model not only as a classifier or detector but also as a flexible inference engine that accepts natural-language prompt sentences from the server or the user. Without such a mechanism, the system cannot efficiently reuse a single generative model instance for both structured risk evaluation and user-facing explanations, leading to the need for multiple specialized models, redundant memory usage, and complex orchestration logic.

Accordingly, there is a need for an improved computer-implemented system that (i) converts communication information into model-ready numerical representations in a structured and efficient manner, (ii) coordinates a generative learning model through server-generated prompt sentences to obtain both risk evaluation information and explanation information, (iii) integrates server-side risk evaluation with server-controlled user interface restrictions on a terminal apparatus, and (iv) records communication histories and user interaction histories in a unified data structure suitable for continuous learning and parameter updating. By addressing these issues, the invention aims to improve the technical operation of servers and terminal devices in real-time communication monitoring, reduce computation redundancy, and enhance detection accuracy and responsiveness through a tightly integrated generative AI-based processing pipeline.

The specific processing by the specific processing unit 290 of the data processing device 12 in Application Example 1 is realized by the following means.

The present invention provides a server comprising a processor and a storage device, the processor being configured to receive communication information obtained from a terminal apparatus via a communication device, normalize and structure the communication information as character information, convert the communication information into a numerical representation by using a natural language processing technique, construct an instruction sentence based on the numerical representation for input to a generative learning model, input the instruction sentence as a prompt sentence into the generative learning model, obtain, from the generative learning model, risk evaluation information and explanation information indicating whether the communication information is related to a criminal act, determine, based on the risk evaluation information, an evaluation value and a category indicating a degree of danger of the communication information, generate warning information and communication restriction information according to the evaluation value and the category, transmit notification information including the warning information and the communication restriction information to the terminal apparatus so as to control a display form or an operation permission state of the communication information on the terminal apparatus, and record the communication information, the risk evaluation information, the evaluation value, and the category as history information in the storage device and use the history information for learning or parameter updating of the generative learning model. This enables a tightly integrated, server-centric processing architecture in which communication information is efficiently transformed into model-ready numerical data, generative AI-based risk evaluation and explanation generation are executed in response to structured prompt sentences, user-facing warnings and interaction restrictions are consistently enforced at the terminal under server control, and accumulated communication and interaction histories are cyclically fed back to improve the performance and adaptability of the generative learning model, thereby enhancing accuracy, responsiveness, and resource efficiency of the overall computer system.

The term “system” refers to a combination of at least one server, at least one terminal apparatus, and one or more communication and storage components that cooperate to execute the functions described in the claims.

The term “server” refers to an information processing apparatus including at least one processor, a memory, and a communication interface, configured to perform centralized processing of communication information and to interact with one or more terminal apparatuses over a network.

The term “processor” refers to one or more hardware processing units, such as a central processing unit or a graphics processing unit, capable of executing instructions to perform arithmetic operations, logical operations, and control operations specified by a program.

The term “storage device” refers to a hardware storage component, such as a semiconductor memory, a magnetic storage medium, or an optical storage medium, configured to store programs, models, parameters, communication information, and history information.

The term “communication device” refers to a hardware or software communication interface, such as a network interface controller or a communication module, configured to transmit and receive data between the server and the terminal apparatus via a wired or wireless network.

The term “terminal apparatus” refers to a user-side electronic apparatus, such as a mobile device, a wearable device, or a general-purpose computing device, configured to send communication information to the server and to display or otherwise present information received from the server to a user.

The term “communication information” refers to information content exchanged via an electronic communication channel, including at least text data and optionally identifiers, links, or metadata associated with a message between users or between a user and a service.

The term “character information” refers to the representation of communication information as a sequence of symbols or code points in a predetermined character encoding format suitable for textual processing.

The term “normalize” refers to the process of transforming communication information into a standardized format, including operations such as unifying character encodings, converting character variants, and applying consistent punctuation or spacing rules.

The term “structure” refers to the process of organizing communication information into predefined fields or formats, such as tokens, sentences, or tagged segments, so that the information can be efficiently processed by downstream computational modules.

The term “natural language processing technique” refers to a computational method for analyzing and processing human language, including operations such as tokenization, part-of-speech tagging, embedding calculation, or sequence modeling.

The term “numerical representation” refers to data that encodes communication information as numbers, such as vectors, matrices, or tensors, which can be directly processed by a machine learning model.

The term “generative learning model” refers to a machine-learned model, such as a neural network trained with generative objectives, that is configured to generate text, predictions, or other outputs in response to input data or prompt sentences.

The term “prompt sentence” refers to a text-based instruction or query provided to the generative learning model, which conditions the behavior of the model and guides the generation of risk evaluation information or explanation information.

The term “instruction sentence” refers to a structured textual input constructed by the server based on numerical representations or other processed data, and used as a prompt sentence for the generative learning model.

The term “risk evaluation information” refers to data indicating a likelihood or degree of association between communication information and a criminal act, including, for example, probability values, scores, or categorical assessments.

The term “explanation information” refers to descriptive text or structured data that explains or justifies a risk evaluation, including reasons, indicative patterns, or contextual factors related to potential criminal activity.

The term “criminal act” refers to an act that is unlawful under applicable regulations or standards, including, but not limited to, fraud, unauthorized access, or other prohibited activities conducted through electronic communications.

The term “evaluation value” refers to a quantitative indicator, such as a numerical score, produced based on the risk evaluation information and used to represent the degree of danger associated with the communication information.

The term “category” refers to a qualitative or discrete classification label, such as a danger level or risk group, assigned to the communication information based on the evaluation value or risk evaluation information.

The term “warning information” refers to data that instructs or alerts a user regarding a potential risk related to communication information, including warning messages, cautionary statements, or recommended actions.

The term “communication restriction information” refers to data specifying limitations or constraints on user operations with respect to communication information, including, for example, prohibiting or restricting selection, activation, or transmission of certain elements.

The term “notification information” refers to information transmitted from the server to the terminal apparatus that includes at least warning information and communication restriction information to be presented to or enforced for a user.

The term “display form” refers to a manner in which communication information and associated warnings are visually or otherwise presented on the terminal apparatus, including layout, highlighting, or emphasis.

The term “operation permission state” refers to a condition that determines whether, and to what extent, a user is allowed to perform operations on communication information, such as selecting, opening, or forwarding content.

The term “history information” refers to stored records that include communication information, risk evaluation information, evaluation values, categories, and optionally user operations, used for analysis, auditing, or model updating.

The term “learning” refers to a process by which parameters of the generative learning model are adjusted based on training data, history information, or feedback so as to improve performance on a specified task.

The term “parameter updating” refers to the modification of internal parameters of the generative learning model, including weights or biases, to reflect new history information or feedback and thereby change the behavior of the model.

The term “user interface” refers to a set of graphical, textual, auditory, or other interaction elements provided on a terminal apparatus, enabling a user to view communication information and warnings and to perform operations thereon.

The term “reference information” refers to portions of communication information that can be selected or activated, such as links, identifiers, or embedded resources, which may lead to further actions or external content.

The term “operation information” refers to data indicating how a user interacts with communication information or the user interface, including selections, confirmations, cancellations, block operations, or ignore operations.

The term “teacher information” refers to labeled data, including operation information and associated risk outcomes, used as supervision signals during learning or updating of the generative learning model.

The term “inquiry sentence” refers to a text input produced by a user, including a question or request for analysis, which is provided to the generative learning model as a prompt sentence to obtain a response.

The term “identification information” refers to data that identifies an entity, such as an account identifier, a contact identifier, or a resource identifier, that may be included in communication information or an inquiry sentence.

The term “risk explanation information” refers to information generated by the generative learning model that explains the assessed risk regarding a criminal act for particular communication information or identification information, and that provides reasoning or guidance to the user.

In one embodiment, a system includes a server, one or more terminal devices, and a communication network connecting them. The server includes at least one processor, one or more memory units, a storage device, and a network interface. The terminal includes at least one processor, a memory, a display, an input interface, and a communication module. The server executes a program that implements conversion of communication information into numerical representations, interaction with a generative AI model using prompt sentences, generation of warning and restriction information, and storage and reuse of history information for continuous learning.

Server uses conventional hardware components such as a central processing unit (CPU), an optional graphics processing unit (GPU) for acceleration of matrix operations, a volatile memory such as random access memory (RAM), and a non-volatile storage device such as a solid-state drive (SSD) or hard disk drive (HDD). Server executes an operating system such as a general-purpose server operating system and a runtime environment capable of running an application framework. Server also executes a machine learning framework such as a tensor-based computation library (for example, TensorFlow-type or PyTorch-type frameworks) and a natural language processing toolkit (for example, frameworks of the transformer family or general-purpose NLP libraries).

Server stores, in the storage device, a generative AI model, auxiliary classification models, and program modules for text preprocessing, prompt sentence construction, risk evaluation, warning generation, communication restriction decision, and history management. Server also stores model parameters including weight matrices, bias vectors, and optimizer state in the storage device.

Server receives communication information from the terminal via the network interface. The communication information includes character strings such as message bodies, identifiers such as sender IDs or account IDs, and optional embedded reference information such as resource locators or contact identifiers. Server converts the received communication information into character information in a unified character encoding, such as a Unicode-based encoding, and normalizes characters by converting variant forms to canonical forms and unifying case, spacing, and punctuation. This normalization eliminates variability that would otherwise increase the dimensionality of the model input and reduces memory consumption and cache misses during downstream processing.

Server structures the normalized communication information into a specific data structure in memory. For example, server allocates a record including fields for a message identifier, user identifier, raw text, normalized text, detected tokens, detected entities, and detected references. Server uses a natural language processing technique such as tokenization and sentence segmentation to split the normalized text into tokens and sentences, and labels tokens with attributes such as token type, part-of-speech, and whether the token represents a reference information candidate. Server then converts tokens into numerical representations using an embedding mechanism. In one embodiment, server uses a transformer-type tokenizer that maps tokens to token indices and constructs attention masks and optional segment identifiers. In another embodiment, server uses a subword tokenizer that reduces out-of-vocabulary problems and improves robustness to obfuscation patterns used in fraudulent messages.

Server constructs a tensor-based numerical representation from the token indices and attention masks. Server stores this representation in memory in a contiguous layout that is aligned for vectorized operations on the CPU or GPU. This layout reduces cache misses and enables efficient use of single-instruction-multiple-data (SIMD) instructions and GPU parallelism. Because the representation is computed once and reused for both risk evaluation and explanation generation, the system avoids redundant processing that would occur in separate pipelines. Server uses a generative AI model that is implemented as a neural network with an encoder-decoder or decoder-only transformer architecture. The generative AI model includes multiple attention layers, each comprising query, key, and value projection matrices, multi-head attention operations, feed-forward layers, and normalization layers. Model parameters are stored in the storage device and loaded into memory when the model is initialized. Server executes forward passes of the model using matrix multiplications and non-linear activation functions to compute contextual embeddings and to generate text tokens in response to prompt sentences.

Server uses the numerical representation of the communication information to construct an instruction sentence that serves as a prompt sentence for the generative AI model. In one embodiment, server converts the evaluation context into a textual form that describes the nature of the communication, a summary of its content, or key extracted attributes. For example, server generates a prompt sentence such as:

System: You are a security analysis assistant. Evaluate the following message and determine whether it is related to fraud or other criminal activity.

Message: “You must verify your bank account immediately. Click this link and enter your password.”

Instruction: Output a risk score between 0 and 1 and a brief explanation.

Server concatenates such instruction text with the original message text or a processed version thereof, and provides the concatenated string as the prompt sentence to the generative AI model. By embedding explicit instructions and constrained output formats in the prompt sentence, server causes the model to follow a specific computational pathway that reduces ambiguity and improves the consistency of risk evaluation outputs. This approach differs from traditional rule-based systems or simple classifiers, because the generative AI model receives a structured meta-description of the task and context, which is tailored by the server for each specific communication instance.

Server also handles user-initiated inquiry sentences as prompt sentences. When user wishes to manually verify a message or account, user inputs text such as:

“Is this message likely to be a scam? ‘We will lock your account in 2 hours unless you pay a reactivation fee.’”

or

“Is this account related to criminal activity? It promises guaranteed 300% returns in 24 hours.”

or

“Please check if the following URL is suspicious: https://my-bank-secure-login-check.com/verify.”

Terminal transmits these inquiry sentences to server. Server then wraps them into a standardized instruction format and passes them to the generative AI model as prompt sentences.

Server, upon receiving the prompt sentence, performs a forward pass through the generative AI model. The model processes the tokenized prompt and generates output tokens that represent risk evaluation information and explanation information. Server decodes the output tokens into text and parses the generated text to extract quantitative values such as a risk score and qualitative explanation segments. In some embodiments, server constrains generation using sampling strategies such as top-k sampling or nucleus sampling with small values, or uses beam search with limited beam width, to balance diversity and determinism.

Server, in one embodiment, augments the generative AI output with a dedicated classification head. Server uses the contextual embedding of a special token (for example, a sequence-level representation) as input to a small feed-forward network that outputs class probabilities for categories such as “high risk,” “medium risk,” and “low risk.” Server computes an evaluation value as a scalar risk score and selects a category based on predefined thresholds. This two-layer architecture, combining generative text output with a discriminative head, improves computational efficiency because the same forward pass produces both embeddings and logits, reducing the number of model invocations.

Server stores the risk evaluation information, evaluation value, category, and relevant context in the storage device as history information. Server uses a structured database schema in a relational database or a key-value store, with fields for communication identifier, time stamp, risk score, category, model version, and user reaction. Server uses indexing on fields such as user identifier and time stamp to accelerate retrieval for model retraining and auditing.

Server generates warning information in textual form for presentation to user. In one embodiment, server uses the generative AI model again to transform the structured risk evaluation into a user-friendly warning. Server constructs a prompt sentence such as:

System: You are a security assistant. Based on the risk score and category, generate a concise warning for the user.

Risk score: 0.93

Risk Category: High

Message: “You must verify your bank account immediately. Click this link and enter your password.”

The generative AI model returns an explanation such as: “This message is very likely to be fraudulent. Do not click the link or enter any account information.” Server treats this as warning information, possibly after post-processing to enforce length limits or content filters.

Server also generates communication restriction information that specifies which operations are to be disabled or restricted on the terminal. For example, server sets flags indicating that selection of a suspicious link should be disabled or that a confirmation dialog must be displayed before allowing the user to proceed. Server stores these flags alongside the warning information and transmits notification information including both warning information and communication restriction information to the terminal.

Terminal receives the notification information from server via its communication module.

Terminal parses the information and updates the user interface accordingly. Terminal uses an application framework running on the device operating system to render communication information and overlay warning information. When server specifies that a link is to be disabled, terminal modifies the event handlers associated with the relevant UI element so that tapping or clicking triggers a warning dialog instead of immediately invoking a browser or another application. This UI control is performed in direct response to server-generated restriction information and thus represents a form of remote device control guided by the server-side risk evaluation pipeline.

User interacts with the terminal by reading the warnings and choosing actions such as blocking the sender, reporting a message as fraud, or ignoring the warning. Terminal detects these user operations and transmits operation information back to server. Operation information includes operation type, time stamp, and context identifiers. Server stores this operation information in the storage device as part of the history information.

Server uses the accumulated history information to improve the generative AI model. In one embodiment, server extracts supervised training examples where user confirmed or contradicted a warning. Server constructs input-output pairs such as (communication text, user-confirmed label) and uses them in fine-tuning the generative AI model or the classifier head. Server defines a loss function such as cross-entropy loss for classification and optionally an auxiliary loss that encourages consistency between generated explanation tokens and correct labels. Server updates the model parameters using an optimization algorithm such as stochastic gradient descent or an adaptive optimizer. Server may also use techniques such as mini-batch training, data augmentation (for example, paraphrasing benign or malicious messages), and regularization to improve generalization and prevent overfitting.

Server thereby creates a closed feedback loop: communication information is processed, evaluated, and restricted in real time; user operations are recorded; and the generative AI model is periodically or continuously updated using this history information. This loop improves detection accuracy over time without requiring manual rule updates. Because server uses structured, normalized data and shared embeddings across tasks, computational overhead is minimized compared to systems that run multiple separate detection engines.

Server achieves specific technical effects in computer operation. By normalizing and structuring communication information once and reusing the resulting numerical representations in both risk scoring and explanation generation, server avoids duplicated tokenization and encoding, which reduces CPU and GPU utilization and improves throughput. By using a single generative AI model to both evaluate risk and generate explanation based on prompt sentences, server reduces memory footprint compared to deploying multiple separate models. By directly controlling the operation permission state on terminal in response to server-generated restriction information, the system reduces the need for repeated round-trips and avoids inconsistent enforcement that would arise from independent client-side heuristics. Furthermore, by storing history information in a structured format optimized for learning, server enables periodic model retraining that uses efficient batch queries and indexing, reducing I/O overhead and training time.

Server also improves technical robustness relative to human-based inspection or static rule systems. For example, server detects obfuscated criminal messages where characters are replaced with similar-looking symbols, because the normalization and subword tokenization reduce the impact of such perturbations. Server uses the multi-head attention mechanism in the generative AI model to capture long-range dependencies and subtle linguistic cues that are difficult to encode in static rules. This yields improved recall and precision in detecting fraud-related communications across large-scale, high-volume data streams.

In alternative embodiments, server uses different neural architectures, such as recurrent neural network-based models or convolutional neural network-based classifiers, or a combination thereof, as the generative learning model or auxiliary classifiers. Server may also vary the numerical representation, such as using character-level embeddings, byte-level embeddings, or hybrid token-character embeddings, to enhance robustness against adversarial perturbations. Server may implement hardware acceleration using specialized inference accelerators for low-latency processing in edge or on-premise deployments.

Terminal, in other embodiments, may be a wearable device, a vehicle-mounted device, or another embedded device. In such embodiments, terminal may use local processing to cache risk evaluation results and apply restriction policies even in intermittent connectivity situations, while synchronizing history information with server when network conditions permit.

User may interface with additional functions provided by server, such as requesting detailed explanations for past decisions or querying why a particular message was classified as high risk. Terminal transmits such explanatory requests as inquiry sentences, and server constructs corresponding prompt sentences that instruct the generative AI model to output step-by-step reasoning, for example: “Explain in detail why the message ‘You must pay a fee immediately to avoid account suspension’ is likely fraudulent.” Server then returns a structured explanation that user can review, further leveraging the generative model's ability to produce human-readable rationales.

Through these embodiments, server, terminal, and user act in a coordinated manner to implement the claimed system. The combination of structured normalization, transformer-based numerical representations, generative AI guided by prompt sentences, server-controlled UI restrictions, and continuous learning from history information provides a concrete technical solution that improves computer performance and security-related functionality, rather than merely automating a manual review process.

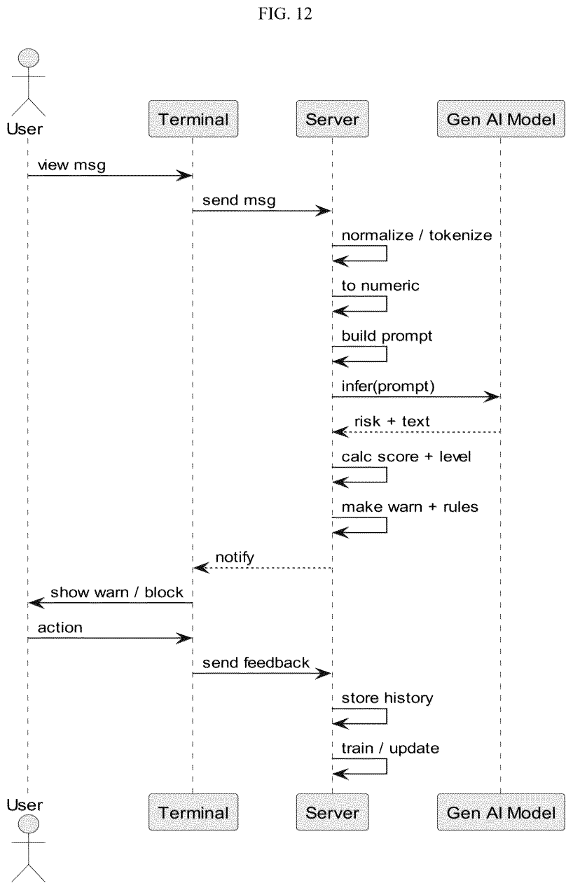

The following describes the processing flow using FIG. 12.
Step 1:

Server receives communication information from terminal via a network interface.

Server takes as input a communication request including fields such as message text, sender identifier, recipient identifier, timestamps, and optional embedded reference information. Server parses the request, verifies authentication data, and stores the raw payload in a temporary buffer in memory. Based on this input, server outputs a structured internal record that encapsulates the communication information in a predefined schema.
Step 2:

Server normalizes character data and structures the communication information.

Server takes as input the structured internal record from Step 1. Server converts text to a unified character encoding, transforms variant characters to canonical forms, applies case-folding where appropriate, and removes control characters and redundant whitespace. Server then segments the normalized text into tokens and sentences using a natural language processing module. Based on this input, server outputs a refined record containing normalized text, token lists, sentence boundaries, and annotated reference information positions.
Step 3:

Server converts the structured text into numerical representations suitable for machine learning.

Server takes as input the refined record from Step 2. Server applies a tokenizer associated with a transformer-based language model to map tokens to token indices, generate attention masks, and, if needed, segment identifiers. Server transforms these indices into tensors with fixed length by padding or truncating sequences. Based on this input, server outputs tensor-based numerical representations stored in memory, aligned for efficient processing on a processor or an accelerator.
Step 4:

Server constructs an instruction sentence as a prompt sentence for a generative AI model.

Server takes as input both the normalized text and key attributes from the refined record, such as presence of links or urgency indicators. Server composes a textual instruction that describes the analysis task, includes the message content, and specifies the expected output format, for example a risk score and a brief explanation. Based on this input, server outputs a prompt sentence string such as:

“You are a security analysis assistant. Evaluate the following message and output a risk score between 0 and 1 and a short explanation: ‘[message text]’.”
Step 5:

Server tokenizes the prompt sentence and prepares model input for the generative AI model.

Server takes as input the prompt sentence from Step 4. Server uses a prompt tokenizer to encode the prompt into token indices and attention masks, and packs these into model input tensors. Server may reuse embedding tables or share vocabulary with the numerical representation of the communication text. Based on this input, server outputs a set of tensors representing the prompt sentence, ready to be fed into the generative AI model.
Step 6:

Server performs a forward pass through the generative AI model to obtain risk evaluation and explanation text.

Server takes as input the model input tensors from Step 5. Server executes matrix multiplications in multi-head attention layers, applies nonlinear activation functions in feed-forward layers, and propagates hidden states through the transformer architecture. Server then generates output token logits and decodes them into text representing risk evaluation information and explanation information, for example a numeric risk estimate and a short justification. Based on this input, server outputs a generated text sequence that encodes both a risk indication and an explanation.
Step 7:

Server derives a numerical evaluation value and a category from the generative AI output.

Server takes as input the generated text sequence from Step 6. Server parses the text to extract a risk score, or maps textual labels to numeric values. In some implementations, server also uses a classification head attached to internal embeddings to compute probability scores for categories such as high risk, medium risk, and low risk. Based on this input, server outputs an evaluation value (e.g., a scalar risk score) and a category label that summarize the degree of danger associated with the communication information.
Step 8:

Server generates warning information and communication restriction information.

Server takes as input the evaluation value and category from Step 7, along with the original communication context. Server applies decision rules that map ranges of the evaluation value and types of content to specific warning messages and restriction policies, such as disabling link activation or requiring additional confirmation. Server composes a warning text tailored to the message and its risk level, and constructs restriction flags describing which user interface operations are to be allowed, blocked, or gated. Based on this input, server outputs structured warning information and communication restriction information.
Step 9:

Server constructs and transmits notification information to terminal.

Server takes as input the warning information and communication restriction information from Step 8. Server embeds these into a response payload together with identifiers that link the notification to the corresponding communication. Server then transmits this payload to terminal over a secure communication channel. Based on this input, server outputs a network response containing notification information that terminal can use to alter its user interface behavior.
Step 10:

Terminal receives notification information and updates the user interface state.

Terminal takes as input the notification information from Step 9. Terminal parses the payload and associates the warning and restriction information with the corresponding displayed communication. Terminal updates visual elements such as banners, icons, and highlight colors, and modifies event handlers to enforce restrictions, for example by preventing direct activation of suspicious links. Based on this input, terminal outputs an updated user interface state that visually warns user and technically restricts certain operations.
Step 11:

User views the warning and selects an action.

User takes as input the updated display presented by terminal, including the communication content, warning text, and any indicated restrictions. User reads the warning and chooses an available action, such as blocking the sender, reporting the message, requesting more details, or dismissing the warning. Based on this input, user outputs a user operation, which terminal captures as interaction data.
Step 12:

Terminal transmits user operation information to server.

Terminal takes as input the user operation from Step 11, including the selected action type and the associated message identifier. Terminal constructs an operation record and sends it to server via the communication module. Based on this input, terminal outputs a structured operation information message that represents user feedback regarding the risk evaluation.
Step 13:

Server records communication information, risk evaluation, and user operation as history information.

Server takes as input the operation information from Step 12, together with the original communication record, evaluation value, category, and generative AI output. Server writes these data into a history database with appropriate indexing on user, time, and risk level. Server may also aggregate statistics such as counts of confirmed frauds or false alarms. Based on this input, server outputs persistent history entries that can be accessed for model retraining and system monitoring.
Step 14:

Server selects and preprocesses history information for model learning or parameter updating.

Server takes as input a set of history entries retrieved from the storage device based on criteria such as recency, user-confirmed labels, or underrepresented categories. Server cleans and balances the data, generates training labels from user operations, and formats the text and labels into batches suitable for learning. Based on this input, server outputs training batches that contain numerical representations of communication texts or prompt sentences paired with target outputs.
Step 15:

Server updates generative AI model parameters using history-based training batches.

Server takes as input the training batches from Step 14. Server computes forward passes for each batch, evaluates a loss function (such as cross-entropy for classification and language modeling loss for explanation tokens), and computes gradients with respect to model parameters. Server then updates weight matrices and bias vectors using an optimization algorithm, adjusting internal parameters to better align future outputs with user-confirmed outcomes. Based on this input, server outputs an updated set of model parameters, which are stored in the storage device and used in subsequent inference steps.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional content monitoring systems for detecting criminal or fraudulent intent in outgoing messages have relied on rule-based filters, static keyword lists, or offline batch analysis. Such techniques suffer from several technical deficiencies. First, they provide limited contextual understanding of natural language, resulting in high false positive rates for benign text and high false negative rates for subtly worded criminal solicitations. Second, they often require message analysis to be performed as a separate, asynchronous process, which introduces latency and prevents interactive feedback to the user at the time of message composition. Third, when large-scale machine learning models are introduced, existing systems typically treat the models as opaque classifiers and do not standardize how input text is preprocessed or how prompts and outputs are structured. As a result, the same underlying model may behave inconsistently across different messages, making it difficult to integrate into a reliable, real-time monitoring workflow. Moreover, conventional architectures do not clearly separate or optimize the technical pipeline from user input acquisition, through text normalization and model-facing prompt construction, to automated parsing of model responses and generation of user-interface-ready alerts. This lack of an end-to-end, machine-oriented protocol for interaction with a generative artificial intelligence model leads to inefficient utilization of computational resources, increased network and processing overhead, and complex bespoke logic on the client side. In particular, when multiple client terminals request analysis concurrently, the server cannot consistently generate structured inputs and outputs for the generative model, causing scalability and maintainability issues. Accordingly, there is a need for a computer-implemented technique that improves the functioning of a server-based message monitoring system by: (i) standardizing the preprocessing and representation of user-input text into a form suitable for analysis by a generative AI model, (ii) generating prompt sentences with predefined structures and constraints that drive the model to produce consistent, machine-parseable responses, and (iii) automatically deriving risk evaluations and alert information from such responses in real time. By improving these technical components and their interaction, the overall system can more efficiently and accurately determine whether messages are related to criminal or improper activity, and can provide immediate, structured feedback to user terminals before transmission of the messages.

The specific processing by the specific processing unit 290 of the data processing device 12 in Example 2 is realized by the following means.

The present invention provides a server comprising a processor configured to receive, via a communication apparatus, a message to be transmitted that is input by a user through an input apparatus; to perform preprocessing on the message to be transmitted, the preprocessing including unifying character types, deleting unnecessary characters, and normalizing a format of the message to be transmitted, and to convert the preprocessed message to be transmitted into text data that is processable by a generative information processing model; to generate a prompt sentence including the preprocessed text data, the prompt sentence having a predefined structure comprising command content that instructs the generative information processing model to determine whether the message to be transmitted is related to criminal or improper activity and constraint conditions that instruct the generative information processing model to output a determination result and a reason for the determination in a predetermined format, and to input the prompt sentence to the generative information processing model; to obtain evaluation information indicating a possibility that the message to be transmitted is related to criminal or improper activity by receiving a response text from the generative information processing model and parsing the response text for predetermined keywords or structured data corresponding to at least one of a classification result and a probability value; to determine a risk level for the message to be transmitted based on the evaluation information and to generate alert information when the risk level satisfies a predetermined condition; and to transmit, via the communication apparatus, notification information including the alert information, associated with the message to be transmitted, to the input apparatus for display. This enables the server to technically improve computer-based content monitoring by transforming unstructured user input into standardized, model-ready text, enforcing a structured prompt and response protocol with the generative AI model, and automatically producing real-time, machine-parseable risk assessments and alerts that can be presented to the user before message transmission, thereby enhancing accuracy, consistency, and efficiency of criminal-content detection in a networked computing environment.

The term “processor” refers to a hardware or virtual computing element, such as a central processing unit or a processing core of an information processing apparatus, that executes instructions to perform the functions described in the present specification.

The term “communication apparatus” refers to a hardware or software communication interface, such as a network interface controller, a wireless communication module, or a communication middleware component, that enables data transmission and reception between the server and an external apparatus over a communication network.

The term “input apparatus” refers to a user-operated device or interface, such as a terminal device, a display with a graphical user interface, a keyboard, or a touch panel, through which a user inputs a message to be transmitted to a recipient.

The term “message to be transmitted” refers to electronic text information, such as a sentence, a phrase, or a collection of characters, that a user intends to send from a terminal device to another device or system.

The term “preprocessing” refers to a sequence of operations applied to the message to be transmitted, including but not limited to unifying character types, deleting unnecessary characters, and normalizing text format, so as to transform the message into a standardized representation suitable for machine processing.

The term “character types” refers to categories of characters in a character encoding system, including, for example, uppercase and lowercase alphabetic characters, numerical characters, and different width or style variants, which may be unified during preprocessing.

The term “unnecessary characters” refers to characters or symbols that do not contribute to the semantic analysis of the message, such as redundant whitespace, control characters, noise symbols, or extraneous markup, which can be removed during preprocessing.

The term “normalizing a format” refers to adjusting the representation of the message, such as unifying punctuation usage, line breaks, or encoding forms, to a standardized format that reduces variation and ambiguity for subsequent analysis.

The term “text data that is processable by a generative information processing model” refers to a machine-readable text representation of the message, after preprocessing, that satisfies structural and encoding requirements for input to a generative artificial intelligence model.

The term “generative information processing model” refers to a machine learning model, such as a generative artificial intelligence model or a large language model, that has been trained on data to generate or evaluate text and to output responses based on input prompt sentences.

The term “prompt sentence” refers to a text sequence provided as input to the generative information processing model, the text sequence including the preprocessed message and additional instructions or constraints that define a task for the model.

The term “predefined structure” refers to a predetermined arrangement or format of elements in the prompt sentence, including specific instruction segments and constraint segments, designed to induce consistent and machine-parseable outputs from the generative information processing model.

The term “command content” refers to a part of the prompt sentence that instructs the generative information processing model to perform a particular operation, such as determining whether the message to be transmitted is related to criminal or improper activity.

The term “constraint conditions” refers to parts of the prompt sentence that specify limitations or requirements regarding the output of the generative information processing model, such as a required output format, output fields, or response style.

The term “criminal or improper activity” refers to activity that is illegal, fraudulent, or otherwise contrary to predetermined rules or policies, including but not limited to fraud, financial scams, and solicitation of unlawful conduct.

The term “response text” refers to text data output by the generative information processing model in response to the prompt sentence, the text data including, for example, a classification label, a probability value, and an explanatory description.

The term “evaluation information” refers to information derived from the response text that indicates a likelihood or degree of association between the message to be transmitted and criminal or improper activity, and that can be used to assess risk.

The term “classification result” refers to a categorical output in the response text, such as a label indicating whether the message is related or not related to criminal or improper activity.

The term “probability value” refers to a numerical value indicating a likelihood or confidence level associated with a classification result, as derived from the response text or output representation of the generative information processing model.

The term “parsing the response text” refers to analyzing the response text using a syntactic or structural analysis process, such as searching for predetermined keywords, patterns, or data structures, to extract evaluation information.

The term “predetermined keywords” refers to specific text tokens or patterns defined in advance, such as fixed labels or markers, that are used to identify relevant portions of the response text when extracting evaluation information.

The term “structured data” refers to data within the response text that follows a specified format, such as a key-value representation, a list, or a markup structure, which facilitates automatic extraction and interpretation of evaluation information.

The term “risk level” refers to a quantified or categorized indication of the degree of risk that the message to be transmitted is related to criminal or improper activity, determined based on the evaluation information.

The term “predetermined condition” refers to a threshold, rule, or logical criterion defined in advance, which specifies when the risk level is high enough to trigger generation of alert information.

The term “alert information” refers to information generated by the processor to indicate that the message to be transmitted may be related to criminal or improper activity, and that may include warning text, risk indicators, or guidance to the user.

The term “notification information” refers to data transmitted from the server to the input apparatus, the data including the alert information and being formatted for presentation to the user, for example in a graphical user interface.

The term “server” refers to a computing system or node, comprising at least one processor and associated memory and communication resources, that executes the processes described in the present invention and communicates with one or more input apparatuses over a network.

In one embodiment, a server implements the claimed system as a network-accessible content monitoring platform. The server includes at least one processor, a memory, and a communication apparatus connected to a communication network. The server executes a program stored in the memory to perform the functions described below. A terminal operates as an input apparatus and display apparatus, and a user interacts with the terminal to input a message to be transmitted. The server and the terminal communicate via a wired or wireless communication link, such as an Internet connection using a transport protocol.

The server executes an operating system such as a general-purpose server operating system and runs an application framework, such as a web application framework or application server, to provide an interface for receiving messages from the terminal. The server includes a communication module that terminates secure connections (for example, HTTPS sessions) and parses structured request data sent from the terminal. The terminal executes a client application, such as a web browser or a dedicated application, that renders an input screen to the user and sends the user's input to the server.

The server uses a preprocessing module implemented, for example, in a high-level programming language such as a scripting or compiled language, to transform a message to be transmitted into normalized text data. The server stores the received message as a string in a memory structure, such as a character array or an immutable string object, and applies successive transformations. The server unifies character types by converting variant representations (for example, full-width and half-width characters, or mixed Unicode representations) into a canonical encoding. The server deletes unnecessary characters, such as redundant whitespace, non-printable control codes, and extraneous markup. The server normalizes the format by standardizing punctuation, line breaks, and quoting style. The server thus outputs text data that conforms to a predefined internal schema for downstream processing by a generative information processing model.

The server uses a model interface module to construct a prompt sentence for the generative AI model. The server stores a prompt template as a text resource in memory, the template including placeholders for an instruction segment, constraint segment, and message segment. The server embeds the preprocessed text data into this template to generate a complete prompt sentence. In one example, the server generates a prompt sentence of the following form:

“System: You are a compliance monitoring assistant that detects fraud and criminal solicitation in customer-facing messages.

User: Determine whether the following message is related to fraud or criminal activity.
1. Answer strictly in JSON with the fields ‘label’ (‘fraudulent’ or ‘not_fraudulent’) and ‘reason’ (a one-sentence explanation).
2. Consider patterns such as vague promises of high returns, pressure to act quickly, and requests for personal or financial information.

Message: ‘There is a special investment opportunity.’”

In another example, the server generates a simpler prompt sentence such as:

“The user is about to send the following message to customers. Determine whether this message is related to fraud or criminal activity, and briefly explain your reasoning. Answer with ‘fraudulent’ or ‘not fraudulent’ and a one-sentence justification. Message: ‘There is a special investment opportunity.’”

The server ensures that the prompt sentence follows a predefined structure so that the generative AI model produces outputs that contain a classification result and an explanation in a machine-parseable layout. The server explicitly encodes constraint conditions in the prompt sentence, such as a requirement that the model output a label and reason in a fixed sequence or delimited form. This structural constraint reduces variability in the output and simplifies the parsing algorithm executed by the server.

The server executes the generative AI model on specialized hardware, such as a graphics processing unit conforming to a parallel processing architecture. The server loads the generative AI model, for example a transformer-based neural network with multiple attention layers, into the memory of the processing device. The generative AI model is implemented using a numerical computation library, such as a tensor computation framework, which performs matrix multiplications, vector additions, and non-linear activation functions by invoking optimized kernels on the processing device.

The server uses a tokenizer module to convert the prompt sentence into a sequence of token identifiers. The tokenizer maps substrings of the prompt sentence into integer indices according to a predefined vocabulary. The server arranges these indices into a tensor data structure, such as a one-dimensional or two-dimensional array of integers, and supplies the tensor to the generative AI model. The model includes an embedding layer that maps token identifiers to dense vectors, one or more self-attention blocks that compute contextualized representations by combining tokens with learned attention weights, and feed-forward layers that project intermediate vectors into higher-level feature spaces. The generative AI model computes scores over a vocabulary of possible next tokens using a linear transformation and a softmax function.

The server configures the generative AI model such that the output distribution is biased toward short, structured responses. For example, the server may limit the maximum number of generated tokens and adjust decoding parameters, such as temperature and top-k or top-p thresholds, to produce deterministic and reproducible outputs. The generative AI model, when applied to the prompt sentence, calculates feature representations that capture semantic relationships between segments of the message and patterns learned during training from historical data related to fraudulent offers and criminal solicitations. During training, the generative AI model has been optimized by minimizing an error function, such as cross-entropy loss, between predicted token distributions and target token sequences. The training process has updated model parameters, such as weight matrices in each layer, using a gradient-based algorithm such as stochastic gradient descent with an adaptive optimizer.

The server, executing the model interface module, collects the response text produced by the generative AI model. The response text may be a short textual output such as “fraudulent-This message fits a common pattern of vague ‘special investment opportunities’ used in investment scams.” Alternatively, the response text may be formatted in a structured style that includes labeled fields. The server stores the response text in a buffer and initiates a parsing operation. The server uses a parsing module that searches for predetermined keywords, such as “fraudulent” or “not_fraudulent,” and identifies their positions in the response text. The server may also use a simple grammar or pattern-matching rule, expressed in regular expressions or equivalent pattern specifications, to extract the label and associated reason string. By designing the prompt sentence to induce consistent output patterns, the server simplifies this parsing step and reduces computational overhead compared to general-purpose language parsing.

The server converts the extracted label and any associated probability information into evaluation information. In one embodiment, the server maps the label to an internal risk level, such as a high-risk, medium-risk, or low-risk category, stored as an enumeration or numeric code in memory. The server may compute a numeric risk score by combining a confidence indication encoded in the response text with internal thresholds. The server stores this evaluation information in a data structure, such as a record or object that includes fields for the original message, normalized text, label, risk level, and explanation.

The server determines whether the risk level satisfies a predetermined condition stored in configuration data. For example, the server may define that any message labeled as fraudulent or any message with a risk score above a threshold should trigger the generation of alert information. The server generates alert information by constructing a warning sentence, such as “This message may be related to fraud or criminal activity. Please review and revise the content before sending.” The server associates the alert information with the original message identifier and prepares notification information, such as a payload including both the alert text and optional structured fields, for transmission to the terminal.

The server transmits the notification information to the terminal via the communication apparatus. The terminal receives the notification information through its client application, parses the data, and updates its graphical user interface. The terminal displays the alert information to the user in a distinctive visual format, such as a highlighted warning panel or a dialog box. The user thus receives real-time feedback before finalizing the transmission of the message and may choose to modify or cancel the message. The user can input a revised message and cause the terminal to send the revised message to the server for re-analysis.

The server thereby provides a concrete technical improvement over conventional systems. By standardizing text preprocessing, prompt sentence structure, and response parsing, the server reduces variability in interactions with the generative AI model, minimizing the need for extensive post-processing and manual review. The server uses hardware acceleration and efficient tensor operations to evaluate messages in near real time, improving processing speed and enabling interactive feedback rather than delayed, batch-style processing. The server also reduces communication load by sending compact, structured messages instead of large unstructured logs, and by avoiding repeated transmission of full historical context for each request.

The server achieves improved accuracy compared to simple keyword-based filters because the generative AI model uses high-dimensional feature representations that capture contextual semantics. The self-attention mechanism in the model allows the system to recognize subtle combinations of words that indicate fraudulent intent, even when obvious keywords are absent or obfuscated. The model's weights encode learned, non-obvious correlations that a human-defined rule set would not capture. As a result, the server can reduce both false positives and false negatives, which in turn reduces unnecessary alerts and missed detections.

The server's processing is not a mere automation of human reading and judgment. Human reviewers typically read messages sequentially and rely on hand-crafted guidelines. In contrast, the generative AI model executes a defined numerical algorithm: tokenization, embedding, multi-head attention, and feed-forward transformations applied in parallel to all tokens, using weight matrices and activation functions. The server controls this algorithm by specifying precise prompt structures and decoding parameters to achieve predictable, bounded behavior. The server's preprocessing, prompt generation, and response parsing form a technical protocol that coordinates multiple software modules to achieve an effect that would not be attainable by human review alone in the same time frame and at the same scale.

In one alternative embodiment, the server deploys the generative AI model locally instead of through a remote service. The server stores the model parameters on a storage device and loads them into a memory region attached to the processing unit. The server uses a model-serving component to expose a local inference interface, such as a network or interprocess communication endpoint. The overall data flow and algorithmic steps remain the same, but the server may further optimize throughput by batching multiple messages into a single inference call, combining multiple prompt sentences into one tensor. This batching reduces context switching overhead and improves utilization of the processing unit.

In another embodiment, the server uses a smaller, domain-specific generative AI model that has been fine-tuned on a curated dataset of messages labeled for fraud and criminal content. The server stores a separate set of fine-tuning parameters and may switch between a general-purpose model and the domain-specific model based on message type or system load. The server thus balances accuracy and computational efficiency. The fine-tuned model may use a modified loss function that places higher weight on correct detection of high-risk content, further improving sensitivity to criminal patterns.

In yet another embodiment, the server maintains a log of past evaluation information and automatically updates threshold conditions or parsing rules based on observed performance. For example, the server may decrease the risk threshold when it detects a new wave of messages with borderline patterns that the model labels as fraudulent. The server may also use stored evaluation information to generate additional synthetic examples for further training or calibration of the model, thereby continuously improving detection performance.

The terminal, in all embodiments, remains comparatively simple. The terminal focuses on user interaction and display and delegates complex text analysis and risk evaluation to the server. This division of roles reduces the hardware requirements for the terminal and centralizes model computation on the server, enabling unified updates to model parameters, preprocessing rules, and prompt design. The user thereby benefits from improved detection accuracy and lower latency without requiring any specialized hardware or software on the terminal side.

Through these embodiments, the system realizes a specific, technical configuration for receiving user-entered messages, transforming them into standardized model inputs, executing a structured interaction with a generative AI model, and converting the resulting outputs into real-time risk assessments and alerts. This configuration improves the functioning of the computer system itself by optimizing data representations, leveraging specialized hardware, and coordinating multiple modules with well-defined data structures and algorithms, rather than simply automating an abstract human decision-making process.

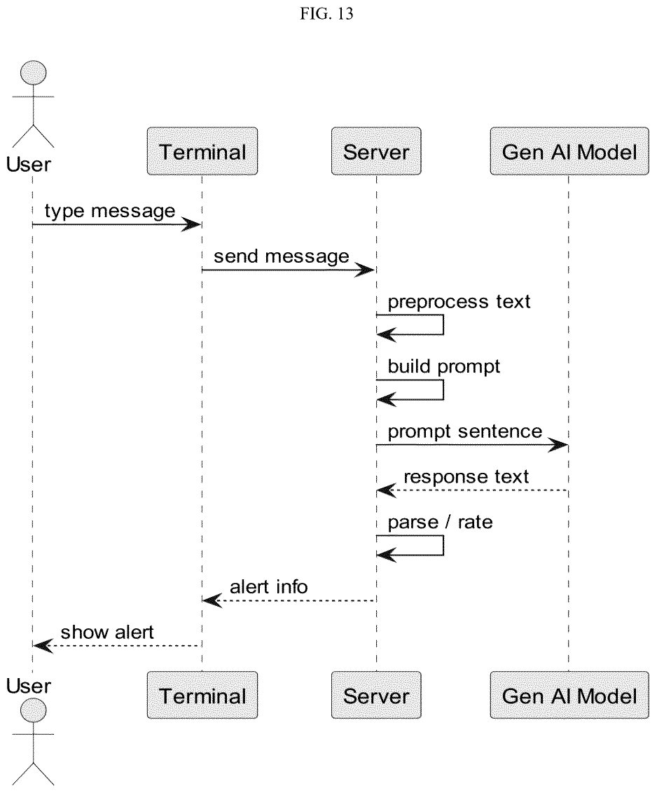

The following describes the processing flow using FIG. 13.
Step 1:

The user operates the terminal to open an input screen, such as a web page or native application view, and inputs a message to be transmitted into a text field.

The input of this step is keystroke events and touch events generated by the user on the terminal.

The terminal converts these events into a character string, for example “There is a special investment opportunity.”, and stores the character string in a text buffer.

The output of this step is a completed text string representing the message to be transmitted, held in the memory of the terminal.
Step 2:

The terminal prepares a transmission request including the message to be transmitted and sends the request to the server via a communication network.

The input of this step is the text string stored in the terminal's buffer in Step 1.

The terminal embeds the text string into a structured request object, for example a payload including a field such as “message”, and serializes the object into a byte sequence suitable for an application-layer protocol. The terminal then opens a secure connection and transmits the serialized data to the server.

The output of this step is a network packet stream containing the message to be transmitted, which is delivered to the server's communication apparatus.
Step 3:

The server receives the transmission request from the terminal and extracts the message to be transmitted from the request.

The input of this step is the network packet stream arriving at the server's communication apparatus.

The server reassembles the packets into a request message, decodes the application-layer protocol, parses the structured payload, and reads the value of the message field into a text variable. The server stores this text in main memory for subsequent processing.

The output of this step is a raw message string, such as “There is a special investment opportunity.”, available as a data object inside the server.
Step 4:

The server performs preprocessing on the raw message string to convert it into normalized text data that is processable by the generative AI model.

The input of this step is the raw message string obtained in Step 3.

The server applies a sequence of text transformation functions: the server unifies character types (for example, converts full-width characters to half-width and converts uppercase letters to lowercase where appropriate), removes unnecessary characters (for example, deletes control characters, redundant spaces, and non-semantic symbols), and normalizes the format (for example, standardizes punctuation and line breaks). These operations are implemented as string replacement, filtering, and mapping operations on the character array.

The output of this step is a cleaned and normalized text string, which is stored as preprocessed text data in the server's memory.
Step 5:

The server generates a prompt sentence for the generative AI model by embedding the preprocessed text data into a predefined prompt template.

The input of this step is the preprocessed text string produced in Step 4.

The server selects a prompt template stored in memory, such as:

“The user is about to send the following message to customers. Determine whether this message is related to fraud or criminal activity, and briefly explain your reasoning. Answer with ‘fraudulent’or ‘not fraudulent’and a one-sentence justification. Message: ‘<MESSAGE>’.”The server performs a template substitution operation, replacing the placeholder <MESSAGE>with the preprocessed text string. This is implemented as a string concatenation or formatted print operation.

The output of this step is a complete prompt sentence text, for example:

“The user is about to send the following message to customers. Determine whether this message is related to fraud or criminal activity, and briefly explain your reasoning. Answer with ‘fraudulent’ or ‘not fraudulent’ and a one-sentence justification. Message: ‘There is a special investment opportunity.’”

The server stores this prompt sentence as a new text object.
Step 6:

The server converts the prompt sentence into a sequence of tokens suitable for numerical processing by the generative AI model.

The input of this step is the prompt sentence text from Step 5.

The server invokes a tokenizer module associated with the generative AI model. The tokenizer scans the prompt sentence, segments it into subword units according to a predefined vocabulary, and maps each subword unit to an integer token identifier. This involves table lookups in a vocabulary dictionary and aggregation of results into an array.

The output of this step is an ordered list or tensor of token identifiers representing the prompt sentence, stored as an array of integers in the server's memory.
Step 7:

The server executes the generative AI model on specialized hardware to obtain a response text based on the tokenized prompt sentence.

The input of this step is the array of token identifiers generated in Step 6.

The server transfers the token array to a processing unit, such as a graphics processing unit, and runs the forward-pass algorithm of a transformer-based neural network. The model first applies an embedding operation to map each token identifier to a dense vector. The model then computes multi-head self-attention by calculating query, key, and value vectors and performing matrix multiplications and weighted summations across tokens. The model applies feed-forward layers with activation functions, such as rectified linear units, to transform the feature vectors. Finally, the model computes output logits over the vocabulary and applies a decoding algorithm to generate output tokens.

The output of this step is an array of output token identifiers corresponding to the generated response, which the server stores in memory.
Step 8:

The server converts the array of output token identifiers into a response text string.

The input of this step is the array of output token identifiers from Step 7.

The server invokes a detokenizer module that maps each token identifier back to a text fragment using the same vocabulary dictionary used in tokenization. The server concatenates the text fragments in order, adjusting spacing and punctuation according to language-specific rules implemented in the detokenizer.

The output of this step is a response text string, for example: “fraudulent—This message fits a common pattern of vague ‘special investment opportunities’ used in investment scams.” The server stores this response text in a buffer.
Step 9:

The server parses the response text to extract evaluation information indicating whether the message to be transmitted is related to criminal or improper activity.

The input of this step is the response text string obtained in Step 8.

The server uses a parsing module that applies pattern-matching rules, such as regular expressions or substring search, to locate predetermined keywords like “fraudulent” or “not fraudulent” within the response text. The server also extracts a reason clause following the label. The server then maps the detected label into an internal code representing a risk category, for example by a lookup table that associates “fraudulent” with a high-risk code.

The output of this step is evaluation information consisting of at least a risk label and an explanation string, stored as fields in a structured record in the server's memory.
Step 10:

The server determines a risk level for the message to be transmitted based on the evaluation information and generates alert information when a predetermined condition is satisfied.

The input of this step is the evaluation record produced in Step 9.

The server compares the risk label or risk score contained in the evaluation information against threshold values stored in configuration data. If the label indicates high risk, the server constructs an alert message string, such as “This message may be related to fraud or criminal activity. Please review and revise the content before sending.” This construction is performed by selecting a template corresponding to the risk level and inserting any relevant details.

The output of this step is alert information, including the alert message string and the associated risk level, stored in a notification data structure.
Step 11:

The server assembles notification information including the alert information and transmits it to the terminal for display.

The input of this step is the notification data structure generated in Step 10 and the original message identifier stored in earlier steps.

The server embeds the alert information and identifiers into a response object, serializes the object into a format accepted by the terminal, and sends it through the communication apparatus over the network connection. The server sets appropriate protocol headers and status codes to indicate successful processing.

The output of this step is a network response containing the notification information, which arrives at the terminal.
Step 12:

The terminal receives the notification information from the server and displays the alert to the user.

The input of this step is the network response sent by the server in Step 11.

The terminal decodes the response, parses the notification fields, and updates its user interface state. The terminal renders the alert message string as a visual element, for example a pop-up dialog or warning banner, and associates it with the original message text displayed on the screen. The terminal may also activate interaction controls, such as buttons to edit or cancel the message.

The output of this step is a visual presentation of the alert information on the terminal's display, enabling the user to recognize the risk and take corrective action.
Step 13:

The user responds to the displayed alert and optionally revises the message to be transmitted.

The input of this step is the visual alert and the original message shown on the terminal screen.

The user decides, based on the alert, whether to proceed or to modify the content. If the user chooses to modify, the user interacts with the terminal to reopen the message input field, edits the text (for example, changes it to “We offer an investment product. Please review the full risk disclosure before deciding.”), and confirms the new content.

The output of this step is a revised message string stored in the terminal, which can be sent again to the server, returning the processing flow to Step 2 for re-analysis.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional content-monitoring systems for detecting crime-related communications in digital networks mainly rely on static keyword lists, manually crafted rules, or simple statistical classifiers. Such systems suffer from several technical deficiencies. First, they cannot adequately capture evolving patterns of crime-related behavior, because the underlying models are not continuously or systematically updated from large corpora of past crime-related data represented in a machine-interpretable form. Second, traditional architectures typically process natural-language messages with shallow parsing only, and do not exploit generative AI models driven by explicit prompt sentences. As a result, the systems lack the ability to flexibly infer nuanced crime relevance and to output structured risk indices and explanatory information in real time. Third, many existing systems treat risk analysis and user interaction as separate layers, without integrating emotion analysis of user inputs into the core risk-scoring pipeline. This leads to warnings that are either overly aggressive or insufficiently tailored to the user's current mental state, thereby lowering system effectiveness and sometimes causing users to ignore or bypass warnings.

From the perspective of computer technology, prior systems also exhibit architectural and performance limitations. Computation is often fragmented: one component performs text preprocessing, another component performs classification, and yet another component controls transmission, with little feedback between these stages. There is typically no unified control logic that (i) obtains crime-related and non-crime-related training data from storage, (ii) converts such data into numerical vectors using natural language processing techniques, (iii) trains a generative AI model and associated models, and then (iv) deploys those models in an integrated inference pipeline that produces both machine-readable risk indices and human-readable explanations based on dynamically constructed prompt sentences. Furthermore, conventional systems do not maintain long-term historical records of emotional states and risk indices per user, and therefore are unable to optimize the timing and intensity of warnings based on time-series patterns. This causes unnecessary processing, redundant warnings, and suboptimal allocation of computational and communication resources.

Accordingly, there is a need for an improved technical solution in which an information processing apparatus, such as a server, orchestrates data acquisition, vectorization, generative AI model prompting, emotion analysis, risk scoring, and transmission control in a unified manner. The technical problem to be solved is to provide a computer-implemented architecture that: (i) accurately identifies crime-related communication content by using generative AI models with explicitly constructed prompt sentences; (ii) computes and uses numerical risk indices in real time to control network transmissions; (iii) integrates emotion analysis to dynamically adjust warning content and timing; and (iv) accumulates and exploits historical emotion and risk data to improve future warning policies and system behavior, thereby improving the functioning of the computer system itself in terms of detection accuracy, robustness to evolving crime patterns, and efficiency of user interaction control.

The specific processing by the specific processing unit 290 of the data processing device 12 in Application Example 2 is realized by the following means.

The present invention provides a server comprising a processor configured to acquire, from a storage device, information related to past events associated with crime, perform preprocessing on the information by using a natural language processing technique, and convert the information into numerical vectors; to generate, based on the numerical vectors and classification information indicating crime-related or non-crime-related labels, a trained information processing model including a generative AI model by using a machine learning algorithm, and store the trained information processing model in a storage device; to receive input information including communication content from a terminal device, perform preprocessing on the input information by using the natural language processing technique, generate a prompt including a prompt sentence that defines processing for causing the generative AI model to extract features related to crime from the input information, input the prompt to the generative AI model, and obtain an analysis result regarding crime relevance of the input information from the generative AI model; to calculate a risk index for the input information based on the analysis result, compare the risk index with a predetermined threshold, determine at least one of permission of continuation of communication, restriction of transmission of the communication, and blocking of transmission of the communication according to a comparison result, and notify the terminal device of a determination result; to estimate an emotional state of the input information or of a user associated with the input information by using an emotion analysis technique, and adjust at least one of expression content and presentation timing of a warning to be presented to the user based on the emotional state and the risk index; to, when the risk index is equal to or higher than a predetermined high level, encrypt notification information including summary information regarding the input information and the risk index and transmit the notification information to an external public organization; and to accumulate, for each user, history information regarding the emotional state and the risk index, and generate control information for updating at least one of future presentation timing and warning intensity of the warning based on a time-series change pattern of the history information. This enables the server to implement an integrated technical pipeline in which crime-related features are learned as numerical representations, real-time communications are analyzed through generative AI models driven by explicit prompt sentences, numerical risk indices and explanatory information are produced and used to control network transmission paths, emotion analysis is incorporated into the risk-scoring and user-notification logic, and long-term emotion and risk histories are exploited to optimize warning behavior, thereby improving the overall functioning, accuracy, adaptability, and efficiency of the computer-implemented content monitoring system.

The term “storage device” refers to any hardware or virtual component configured to store digital information, including but not limited to magnetic storage, solid-state storage, or network-accessible storage, that can be accessed by a processor for reading and writing data.

The term “information related to past events associated with crime” refers to any digital data representing historical incidents or behaviors that have been classified as crime-related or non-crime-related, including text messages, documents, logs, or metadata describing such incidents.

The term “natural language processing technique” refers to any computational method for analyzing or transforming human-readable language, including operations such as tokenization, normalization, part-of-speech tagging, syntactic parsing, semantic analysis, and conversion of text into numerical representations.

The term “numerical vector” refers to any ordered set of numerical values derived from text or other symbolic data, which is suitable for input to a machine learning model and represents features of the original data in a machine-interpretable form.

The term “classification information” refers to any label or indicator that associates a data item with a specific category, such as crime-related or non-crime-related, and that is used as supervisory information in training a machine learning model.

The term “machine learning algorithm” refers to any computational procedure that adjusts parameters of a model based on training data, in order to enable the model to perform tasks such as prediction, classification, or feature extraction without being explicitly programmed for each input instance.

The term “trained information processing model” refers to a model, including parameter values, that has been generated by applying a machine learning algorithm to training data, and that is configured to perform a predetermined information-processing task when executed by a processor.

The term “generative AI model” refers to a machine learning model that, in response to an input including at least one prompt sentence, is configured to generate output data such as text, explanations, or inferred attributes, based on patterns learned from training data.

The term “terminal device” refers to any computing apparatus operated by a user, such as a client computer, communication terminal, or portable device, that is capable of sending input information to a server and receiving output information from the server.

The term “input information” refers to any data received from a terminal device for analysis, including communication content such as text messages, documents, or other user-generated content intended for transmission.

The term “communication content” refers to the substantive portion of input information that conveys a message from a user to a recipient, including but not limited to text, symbols, or transcribed speech intended to be transmitted over a communication network.

The term “prompt” refers to an input structure for a generative AI model that includes at least one prompt sentence and optionally additional data, and that specifies the task or processing to be performed by the generative AI model.

The term “prompt sentence” refers to a natural-language instruction or query included in a prompt and configured to define, for the generative AI model, how the model should analyze or transform the input information.

The term “analysis result” refers to any output generated by the generative AI model or another trained model in response to input information, including inferred attributes such as crime relevance, scores, labels, or explanatory text.

The term “crime relevance” refers to a degree or likelihood that input information is associated with, indicative of, or supportive of a crime-related activity or intention, as determined by a model or algorithm.

The term “risk index” refers to a quantitative indicator, such as a numerical score or value, that represents a level of risk that input information is related to crime, and that is computed based on at least one analysis result.

The term “predetermined threshold” refers to a value or range of values set in advance, against which a risk index or other quantitative measure is compared in order to determine a system action.

The term “permission of continuation of communication” refers to an operation or state in which the system allows a communication process to proceed without restricting transmission of the communication content.

The term “restriction of transmission of the communication” refers to any limitation imposed by the system on how or under what conditions the communication content may be transmitted, including but not limited to requiring user confirmation or modifying routing.

The term “blocking of transmission of the communication” refers to an operation in which the system prevents the communication content from being transmitted to its intended recipient.

The term “emotion analysis technique” refers to any computational method that estimates an emotional state from input information, such as text or metadata, including techniques that infer categories like anger, fear, joy, or sadness and associated intensities.

The term “emotional state” refers to a state of affective condition associated with a user or with content, such as anger, fear, anxiety, joy, or sadness, represented in a form that can be processed by a computer system.

The term “warning” refers to any notification or message generated by the system and presented to a user, which is intended to alert the user to a potential risk or problem associated with communication content or behavior.

The term “expression content of a warning” refers to the linguistic or symbolic form in which a warning is presented, including wording, style, tone, and level of detail of the warning message.

The term “presentation timing of a warning” refers to the point in time or phase of user interaction at which a warning is displayed or otherwise communicated to the user.

The term “external public organization” refers to a body responsible for public safety, law enforcement, or regulatory oversight, external to the system, that may receive notification information for further action.

The term “notification information” refers to data assembled by the system for transmission to an external entity, including at least summary information regarding input information and an associated risk index.

The term “summary information” refers to a condensed representation of input information, which may include selected portions, abstractions, or features, sufficient to indicate the nature of the content without reproducing it in full.

The term “encrypt” refers to the process of transforming information into a format that is unintelligible without appropriate decryption data, in order to protect the confidentiality of the information during storage or transmission.

The term “history information” refers to accumulated records for each user that store past values related to emotional states, risk indices, decisions, or other relevant parameters over time.

The term “time-series change pattern” refers to a pattern or trend derived from values of history information observed over time, representing how certain variables, such as emotional state or risk index, evolve sequentially.

The term “control information” refers to parameters or rules generated by the system and used to adjust or govern future system behavior, including at least timing and intensity of warnings based on historical patterns.

The term “warning intensity” refers to a level of strength or emphasis of a warning, including factors such as urgency, intrusiveness, visual prominence, or degree of restriction imposed on user operations.

The term “transmission operation screen” refers to a user interface provided by a terminal device for confirming or initiating transmission of communication content, such as a screen displaying a message and a send control.

The term “warning information” refers to data provided to a terminal device that represents one or more warnings, including text, icons, or other indicators instructing the terminal device how to present a warning to a user.

The term “transmission process of the communication content” refers to a sequence of operations executed by a terminal device and network components to send communication content from the terminal device to a destination.

The term “explanatory information” refers to information, typically represented in natural language, that explains or justifies a risk index or determination of crime relevance associated with input information.

In one embodiment, a server, one or more terminals, and one or more users cooperate to implement the claimed system. The server includes at least one physical processor, a main memory, a non-volatile storage device, and one or more network interfaces. The server executes an operating system and application programs that implement data acquisition, natural language processing, machine learning, generative AI inference based on prompt sentences, emotion analysis, risk scoring, and control of communication flows. The terminal includes a processor, a memory, a user interface display, input devices such as a keyboard or microphone, and a communication interface for connecting to the server over a communication network.

The server uses general-purpose computing hardware and software frameworks to implement the information processing described in the claims. In one example, the server uses a storage device implemented as a relational database system or a non-relational database system to store past messages, labels, model parameters, and user history. The server uses a programming environment such as a high-level scripting language with natural language processing libraries (for example, a library providing tokenization and lemmatization comparable to NLTK or spaCy). The server uses a machine learning framework such as a deep learning framework comparable to TensorFlow or PyTorch to construct and train a generative AI model and auxiliary classifiers. The server optionally uses an external emotion analysis service comparable to a cloud-based natural language sentiment API or a tone analysis API to obtain emotion labels and scores.

The server generates a program, in the form of executable instructions, that causes the processor of the server to implement the following data transformations and numerical computations on text data. The server retrieves past communication records, such as emails, chat messages, and document texts, from the storage device. Each record includes a text field and a label field that distinguishes crime-related instances from non-crime-related instances. The server normalizes each text string by lower-casing characters, removing or standardizing punctuation, and applying tokenization. The server converts each token to an integer index and then maps each index to a real-valued vector using an embedding matrix stored in memory. The server thereby constructs, for each message, a numerical sequence that represents the semantic content of the message. The server constructs a neural network architecture as the generative AI model. In one embodiment, the server uses a multi-layer transformer architecture including an embedding layer, multiple self-attention layers, and a language modeling output layer. The server defines model parameters including attention weight matrices, feed-forward network weights, and layer normalization parameters. The server uses a loss function, such as a cross-entropy loss between predicted tokens and ground-truth tokens, to train the language modeling part of the generative AI model on a large corpus of general text. The server then fine-tunes the generative AI model using a task-specific dataset consisting of prompts and desired outputs related to crime relevance and explanatory text.

The server, in another embodiment, constructs an auxiliary classifier network that shares the embedding and encoder layers with the generative AI model. The classifier network outputs a scalar risk index between 0 and 1 using a sigmoid output layer. The server uses a supervised learning algorithm with labeled crime-related and non-crime-related messages and minimizes a binary cross-entropy loss using stochastic gradient descent or an adaptive optimization method. The server updates model weights by computing gradients via backpropagation and applying weight updates in mini-batches. The server may perform data augmentation, such as synonym replacement or small perturbations of sentence structure, to increase robustness and reduce overfitting. By integrating the generative AI model and the classifier, the server improves computational efficiency because shared layers are reused during inference, and memory locality is improved.

The server stores the trained models on the storage device in a serialized format and loads them into memory when performing inference. The server also stores configuration parameters, including threshold values for the risk index, mapping rules between emotion categories and warning templates, and timing control rules for warnings.

The terminal allows the user to input communication content, for example, by typing text into an email composition interface or a messaging application, or by providing voice input that the terminal converts into text using a speech recognition component. The terminal packages the communication content and metadata such as user identifier, timestamp, and intended recipient into a structured request and transmits the request to the server over a secure channel, for example, using HTTPS.

The server receives the communication content from the terminal and performs further natural language processing. The server uses the same tokenization and embedding procedure described for training, ensuring that inference and training operate in the same feature space. The server constructs a prompt sentence for the generative AI model that specifies the analysis task to be performed on the input message. For example, the server constructs a prompt such as:

“Judge whether the following message is related to a crime and output a risk score from 0.0 to 1.0 and a short explanation. Message: ‘Please transfer the money today, keep it secret, use this password: 1234.’”

In another example, the server constructs a prompt such as:

“Analyze the user's emotions from the following input and then evaluate whether the situation may be related to a crime. Input: ‘I feel scared walking alone at night.’”

In yet another example, the server uses:

“Analyze the user's message and evaluate the possibility that it is related to a crime. Message: ‘Tonight I feel like hurting someone.’”

The server concatenates the prompt sentence and the user message into a single token sequence and feeds the token sequence into the generative AI model. The generative AI model processes the prompt using its transformer layers and generates an output sequence representing natural language text. The server constrains the output format by using training data and prompt wording such that the output includes a numeric risk expression and explanatory phrases. For instance, the output may be of the form: “Risk score: 0.82. Explanation: The message contains a secret money transfer and a password, which are common patterns in fraud cases.”

The server parses the generated output using explicit rules. The server identifies substrings such as “Risk score:” and extracts the following number as the risk index. The server identifies the remainder as explanatory information, and stores both values in memory. This explicit parsing based on structured prompt sentences and structured output format differs from simple generative text, and creates a machine-readable representation that can be used programmatically to control hardware and network behavior.

The server, in some embodiments, calls an emotion analysis component to estimate emotional state from the same communication content. The server may send the message text to a separate emotion classification model implemented using a neural network, for example a bidirectional recurrent neural network with attention or a transformer-based sentiment classifier. The server defines output classes such as anger, fear, joy, sadness, and neutrality. The emotion model outputs a probability distribution over emotion classes, which the server converts into a dominant emotion label and a confidence score. Alternatively, the server may call an external emotion analysis service and parse the returned labels and scores.

The server combines the risk index from the generative AI model and the emotion state from the emotion analysis component. The server may use a rule such as increasing the effective risk index when fear or anger is detected with high confidence, or decreasing the effective risk index when the context suggests sarcasm or low seriousness. The server thus generates a final risk index that more accurately reflects both semantic content and emotional context. This combined processing improves the accuracy of crime-related detection compared to simple keyword or single-model approaches and directly affects how the server controls communication flows. The server uses the final risk index as a control parameter for network transmission. The server compares the risk index with one or more thresholds stored in configuration. When the risk index is below a lower threshold, the server determines that communication is permitted without warnings and returns a control response to the terminal indicating that transmission can proceed. When the risk index lies between the lower threshold and a higher threshold, the server determines that a warning should be displayed, but allows the terminal to proceed with transmission if the user explicitly confirms. When the risk index exceeds the higher threshold, the server determines that the transmission should be blocked. In that case, the server constructs a response that instructs the terminal to cancel the send operation and to display a blocking message. The server may also, when the risk index exceeds an even higher critical threshold, assemble notification information containing a summary of the message and the risk index, encrypt this information, and transmit it to an external public organization over a secure interface.

The terminal receives the control response from the server and updates its user interface. If the server indicates that transmission is permitted, the terminal continues with the normal network transmission process and sends the communication content to its intended recipient, for example by using an email protocol or a messaging protocol. If the server indicates that a warning is required, the terminal displays the warning text and explanatory information obtained from the server, such as:

“This message may be related to fraud (risk score: 0.65). Reason: The content requests a money transfer and emphasizes secrecy.”

The terminal may provide buttons or interface elements allowing the user to cancel or proceed, in accordance with policy. If the server indicates that transmission is blocked, the terminal disables the send button or cancels the queued send operation. In response, the user cannot send the blocked content, and the terminal may display a message such as:

“This message appears to be highly related to fraudulent or dangerous activity and cannot be sent.”

The server tailors the wording and timing of warnings based on the emotion analysis result. When the emotion state indicates anger, the server selects a warning template with a calm and de-escalating style, for example:

“This message may contain inappropriate or risky content. Please review it calmly before sending.”

When the emotion state indicates fear or anxiety, the server selects a reassuring template, such as:

“This message may be associated with a risky situation. For your safety, the system has applied protective measures. Please consider seeking help if you feel threatened.”

The server stores historical records of each user's emotional states and corresponding risk indices in the storage device, using a structured format, for example a table with fields for user identifier, timestamp, emotion label, risk index, and resulting action. The server periodically analyzes these historical records using a statistical or machine learning method. For example, the server computes time-series features such as daily and weekly patterns of emotion, autocorrelation of high-risk events, or clustering of similar episodes. The server uses such analysis to generate updated control information, such as specific time windows in which warnings should be softened or intensified, or user-specific adjustments to thresholds. The server then updates the configuration, so that future real-time decisions reflect these patterns. This long-term feedback loop improves communication load management, reduces unnecessary warnings, and concentrates computational resources on higher-risk situations.

The server, by combining generative AI inference with prompt sentences, structured parsing of model outputs, and emotion-aware control rules, implements logic that is not a mere automation of human review. Human reviewers typically read content and apply ad hoc judgment without computing explicit numerical risk indices, without consistent threshold-based control over network interfaces, and without integrating structured emotion time-series analysis. In contrast, the server implements specific algorithms for tokenization, embedding, neural network inference, gradient-based training, threshold comparison, and encryption, all operating on defined data structures in memory and storage. The combination of these components yields technical effects such as faster analysis per message, improved detection accuracy under evolving crime patterns, reduced false positives and false negatives, and reduced bandwidth and processing load due to proactive blocking of high-risk transmissions.

In alternative embodiments, the server may vary the architecture of the generative AI model. For example, the server may use an encoder-decoder transformer architecture where the encoder processes the prompt sentence and user message, and the decoder generates a structured output in a constrained template. The server may also use a hierarchical attention mechanism to focus on specific segments of the message that historically correlate with crime-related patterns, thereby reducing computation and improving interpretability. The server may adjust hyperparameters such as number of layers, hidden dimension size, attention heads, learning rate, and batch size according to available computational resources and required performance.

The server may also implement different emotion analysis structures. In one variation, the server uses a convolutional neural network applied over word embeddings to capture local emotional cues such as exclamation marks and specific phrases. In another variation, the server uses a multi-task learning architecture where the same model jointly predicts crime relevance and emotion classes, reducing redundancy and improving generalization. In all such embodiments, the server maintains explicit data flows, parameter updates, and inference operations that can be described algorithmically and executed deterministically on computing hardware.

The terminal can also take different forms. In one embodiment, the terminal is a desktop computer running a messaging client application. In another embodiment, the terminal is a mobile device running a messaging application that communicates with the server via a mobile data network. In each case, the terminal follows control instructions from the server concerning whether to permit, warn, or block transmission. The terminal thereby effectively acts as an actuator for the server's risk-based decisions, and the system as a whole controls the flow of communication over the underlying network infrastructure.

By organizing data structures, learning algorithms, and control logic as described above, the server improves computer technology in several ways. The use of shared representations between the generative AI model and classifier reduces redundant computation and improves throughput. The structured use of prompt sentences and constrained output formats enables the generative AI model to produce machine-readable outputs that can be parsed deterministically, reducing post-processing complexity. The integration of emotion analysis reduces error rates in risk assessment and optimizes warning timing, which in turn reduces the number of unnecessary network transmissions and user interactions. The continuous accumulation and analysis of time-series history enables dynamic adjustment of thresholds and templates, improving long-term performance without manual rule tuning. These technical effects demonstrate that the system is not directed merely to an abstract business process, but instead provides specific improvements to the functioning of computer systems handling natural-language communication and network control.

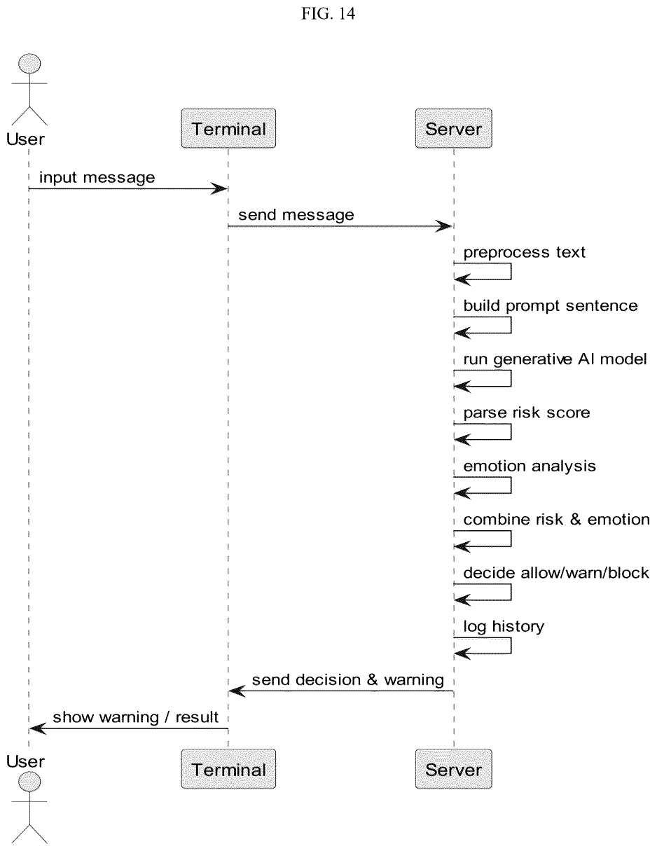

The following describes the processing flow using FIG. 14.
Step 1:

Server acquires training data from a storage device.

Server receives, as input, stored records including text fields (past messages, documents) and label fields (crime-related/non-crime-related) from a database.

Server issues queries to the database, loads the records into memory, and outputs a collection of raw training samples consisting of text strings and associated labels.
Step 2:

Server performs text normalization and tokenization for training data.

Server receives, as input, each raw text string and its label from Step 1.

Server applies a natural language processing library to convert characters to lower case, remove or normalize punctuation, segment the text into tokens (words or sub-words), and output a token sequence and the original label.

Server thereby transforms human-readable text into a structured token list suitable for further numerical processing.
Step 3:

Server converts tokens into numerical vectors.

Server receives, as input, token sequences from Step 2.

Server maps each token to an integer index using a vocabulary table, then uses an embedding matrix to convert each index into a fixed-length real-valued vector.

Server concatenates these vectors into a numerical sequence (for example, a tensor of shape [sequence_length, embedding_dimension]) and outputs the sequence together with the corresponding label.
Step 4:

Server trains a generative AI model and a classifier.

Server receives, as input, numerical sequences and labels from Step 3.

Server initializes parameters of a neural network including a transformer-based generative AI model and a classifier head, feeds batches of sequences through the model, computes a loss function (for example, language modeling loss and/or binary cross-entropy for crime vs non-crime), and updates weights by backpropagation and gradient-based optimization.

Server outputs a trained generative AI model and a trained classifier with learned parameters stored in a model file.
Step 5:

Server stores trained models and configuration.

Server receives, as input, trained model parameters and threshold values determined during validation.

Server writes the model parameters, vocabulary, embedding matrix, and configuration values (such as risk thresholds and warning templates) to a storage device.

Server outputs persistent model files and configuration records that will be reloaded during inference.
Step 6:

User inputs communication content on a terminal.

User provides, as input, communication content by typing text in an application interface or speaking into a microphone on the terminal.

Terminal converts any speech to text if necessary, collects metadata such as user identifier and timestamp, and outputs a composed message object containing the text and metadata.
Step 7:

Terminal sends the message object to the server.

Terminal receives, as input, the message object from Step 6.

Terminal serializes the object into a network request, establishes a secure channel to the server (for example, HTTPS), and transmits the request.

Server receives, as output of this step, a request containing the message text and metadata for analysis.
Step 8:

Server preprocesses the incoming message text.

Server receives, as input, the message text and metadata from Step 7.

Server applies the same natural language processing pipeline used in training: normalization, tokenization, vocabulary lookup, and embedding, to generate a numerical sequence representing the message.

Server outputs a numerical tensor corresponding to the incoming message and preserves associated metadata for later use.
Step 9:

Server constructs a prompt sentence for the generative AI model.

Server receives, as input, the raw message text from Step 7 and control rules from configuration.

Server generates a prompt sentence that defines the analysis task, such as:

“Judge whether the following message is related to a crime and output a risk score from 0.0 to 1.0 and a short explanation. Message: ‘[message text]’.”

Server embeds the actual message text into the prompt, outputs a complete prompt sentence, and prepares it to be used as input for the generative AI model.
Step 10:

Server encodes the prompt as model input.

Server receives, as input, the prompt sentence from Step 9.

Server tokenizes the prompt, converts tokens to indices, and applies the embedding matrix to generate a numerical sequence that represents both the instruction and the user message.

Server outputs a prompt tensor that can be processed by the generative AI model.
Step 11:

Server performs generative AI inference based on the prompt.

Server receives, as input, the prompt tensor from Step 10 and the trained generative AI model from Step 5.

Server feeds the prompt tensor through the generative AI model's transformer layers to compute hidden states and generate an output sequence of tokens representing an answer that includes a risk expression and explanation.

Server decodes the output tokens back into a text response, such as “Risk score: 0.82. Explanation: The message contains a secret money transfer and a password, which are common patterns in fraud cases.” and outputs this generated text.
Step 12:

Server parses the generated output to obtain a risk index and explanation.

Server receives, as input, the generated text from Step 11.

Server applies parsing rules or regular expressions to locate key markers, for example “Risk score:” and extract the following numeric value, and to extract the remainder as explanatory text.

Server outputs a structured record containing a numerical risk index and an explanation string.
Step 13:

Server optionally performs emotion analysis on the message.

Server receives, as input, the original message text from Step 7.

Server either calls an internal emotion classifier or an external emotion analysis service, providing the text as input; the classifier computes a probability distribution over emotion categories based on learned weights and feature extraction, and returns a dominant emotion label (for example, fear or anger) and a confidence score.

Server outputs an emotion record consisting of the emotion label and corresponding score.
Step 14:

Server combines risk index and emotion to refine risk evaluation.

Server receives, as input, the risk index and explanation from Step 12 and the emotion record from Step 13.

Server applies combination rules, such as increasing the effective risk index if the emotion label indicates strong fear or anger with high confidence, and decreasing or leaving unchanged in other cases. The combination may involve linear weighting or a small secondary model.

Server outputs a final risk index and retains the original explanation text.
Step 15:

Server determines communication control action based on thresholds.

Server receives, as input, the final risk index from Step 14 and threshold values from configuration stored in Step 5.

Server compares the risk index to a lower threshold and a higher threshold, and decides one of: allow sending without warning, warn but permit sending, or block sending.

Server outputs a decision code indicating the chosen action and a reference to the explanation.
Step 16:

Server generates a warning message adapted to emotion and risk.

Server receives, as input, the decision code from Step 15, the final risk index from Step 14, the explanation string from Step 12, and the emotion record from Step 13.

Server selects a warning template appropriate to the action (warn or block) and emotion category, inserts dynamic values such as the numerical risk index and explanation, and produces a warning text, for example: “This message may be related to fraud (risk score: 0.82). Reason: The content requests a secret money transfer and a password.”

Server outputs a response object containing the decision code, warning text, and risk index.
Step 17:

Server optionally prepares encrypted notification for an external public organization.

Server receives, as input, the final risk index from Step 14 and the original message text from Step 7.

Server determines whether the risk index exceeds a critical threshold; if so, the server constructs summary information of the message (for example, selected key phrases) and packages it with the risk index into notification information. The server then encrypts this notification information using a cryptographic algorithm and generates an encrypted payload.

Server outputs the encrypted notification and, if required, transmits it to an external public organization; it also records a reference in an audit log.
Step 18:

Server updates user history with emotion and risk data.

Server receives, as input, the user identifier from metadata, the final risk index from Step 14, the emotion record from Step 13, and the decision code from Step 15.

Server constructs a history entry including timestamp, emotion label, risk index, and decision, and writes this entry into a user-specific history table in the storage device.

Server outputs an updated history set for the user, which will be used in later analysis.
Step 19:

Terminal receives the decision and warning from the server.

Terminal receives, as input, the response object from Step 16 over the network.

Terminal parses the decision code, warning text, and risk index, and prepares corresponding user interface messages or control signals.

Terminal outputs a UI state that determines whether to show a warning dialog, allow sending, or block sending.
Step 20:

Terminal presents information and enforces the server's decision.

Terminal receives, as input, the UI state from Step 19.

If the decision code indicates “allow,” terminal proceeds to send the original communication to its intended recipient via the appropriate communication protocol. If the decision code indicates “warn,” terminal displays the warning text on a transmission operation screen and offers controls to cancel or continue. If the decision code indicates “block,” terminal displays a blocking message and cancels the queued send operation, preventing transmission.

Terminal outputs either a completed transmission, a user-confirmed transmission after warning, or a cancelled transmission, thereby enforcing the risk-based control determined by the server.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

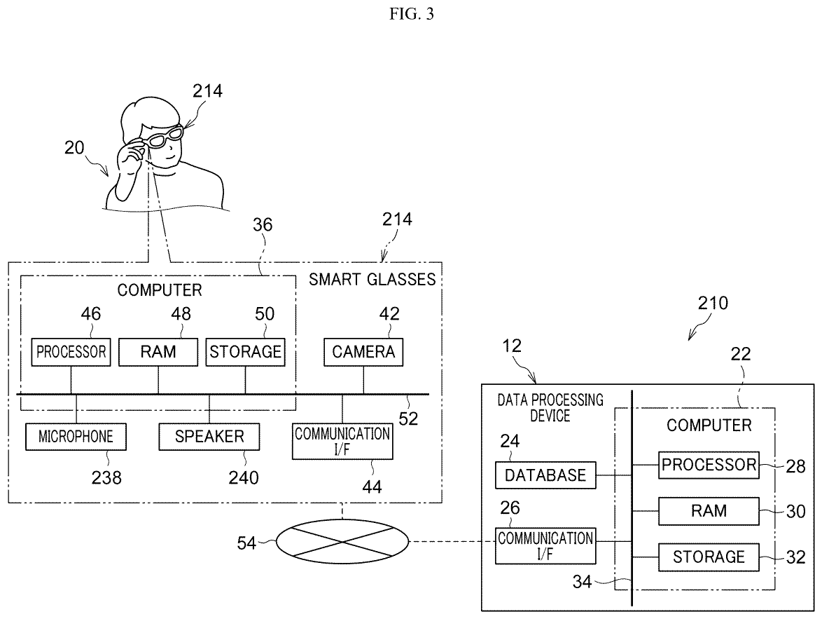

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

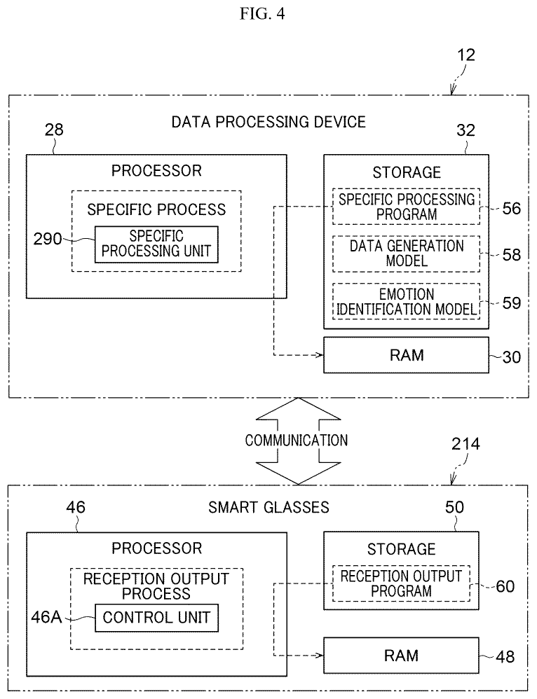

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

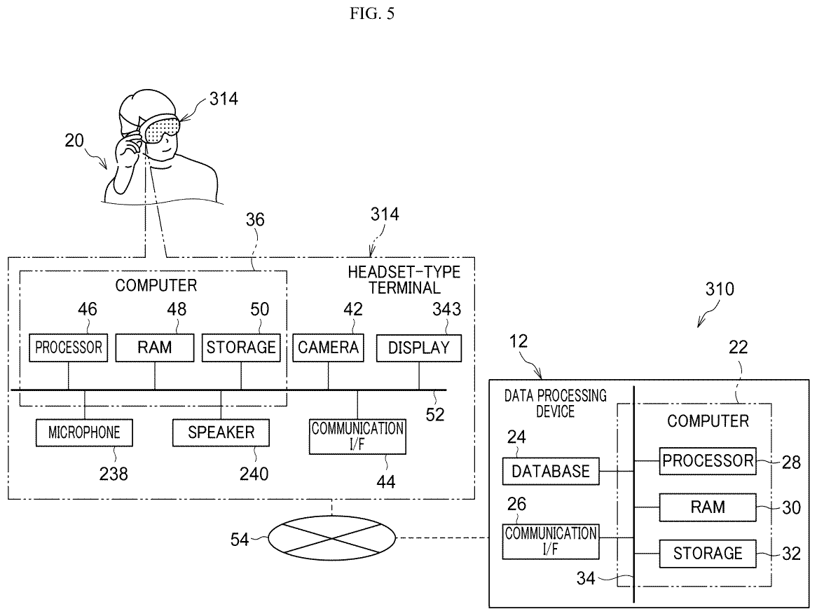

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

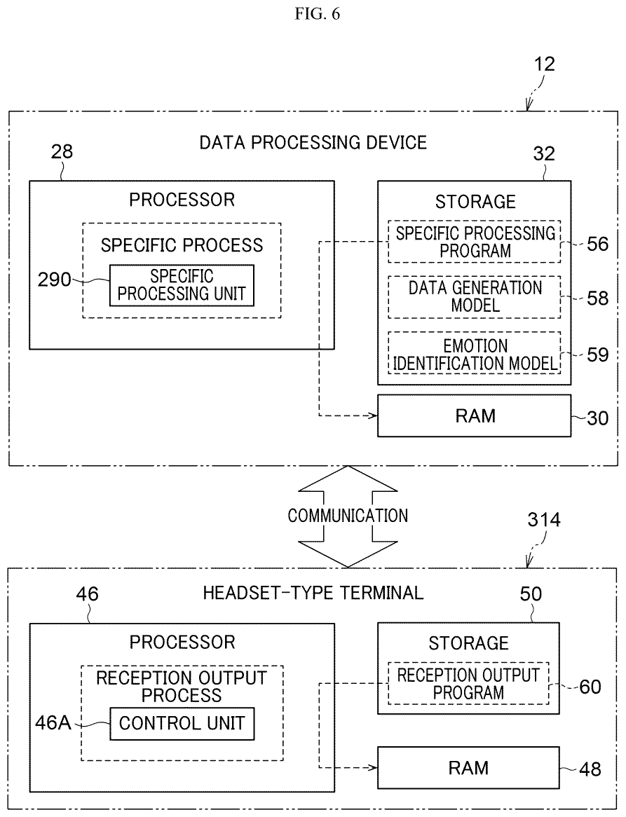

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

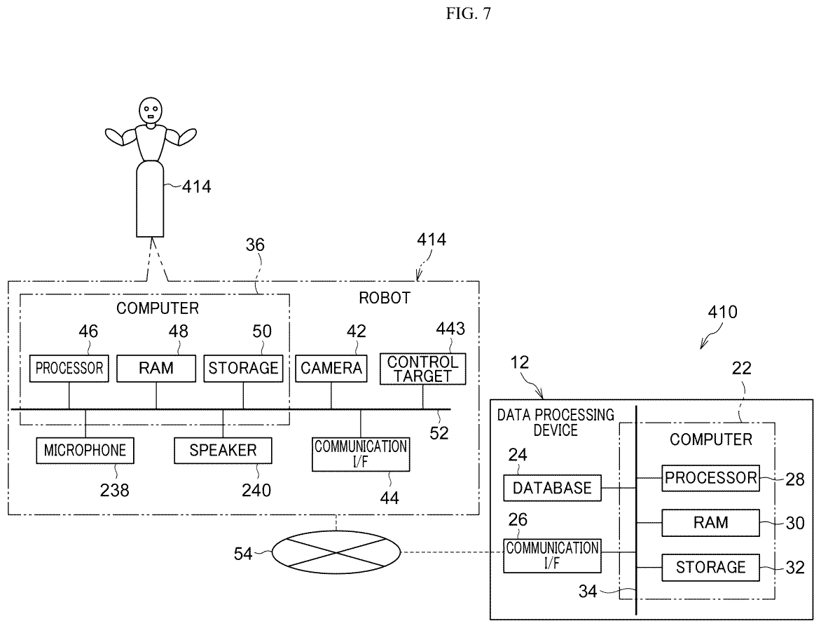

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

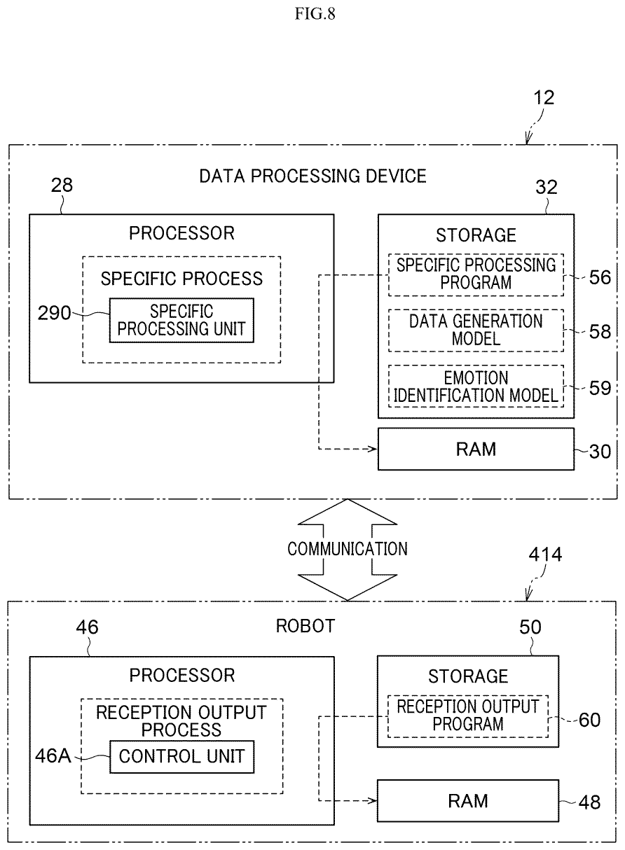

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

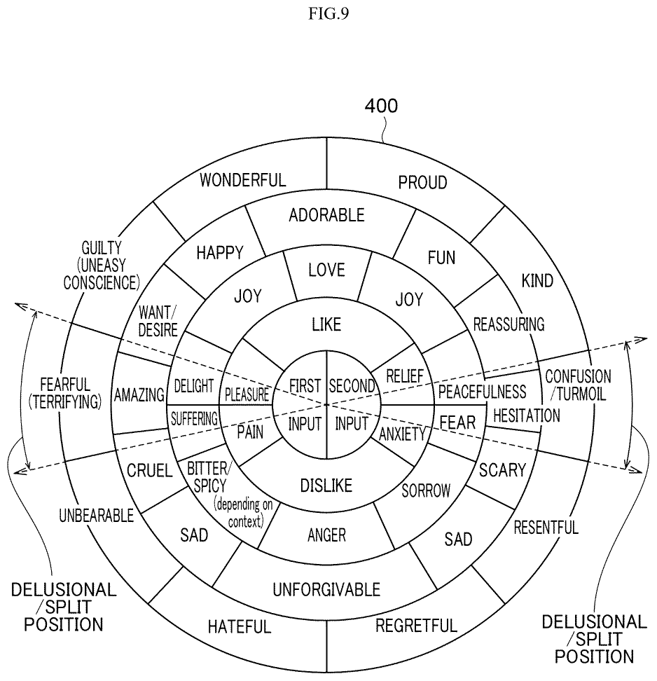

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

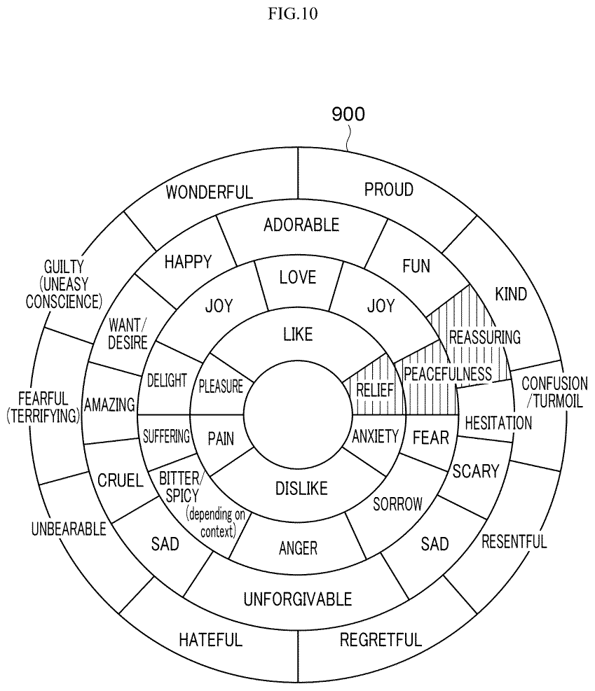

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
acquire, from a storage device, past behavior-related information including text data associated with historical events, and store the past behavior-related information in a working memory, perform preprocessing on the acquired text data, the preprocessing including at least character string normalization, removal of unnecessary elements, and segmentation of the text data into linguistic units, and convert the preprocessed text data into numerical feature data by using a natural language processing technique,
train, by using a machine learning framework, a prediction information processing model based on the numerical feature data and identification information associated with the past behavior-related information, the training including iteratively updating parameters of the prediction information processing model so as to improve a prediction accuracy for behavior relevance,
acquire new text data from the storage device or from an external data source, apply the preprocessing and numerical conversion to the new text data to generate new numerical feature data, input the new numerical feature data to the prediction information processing model, and extract feature information indicating a degree of relevance of the new text data to a behavior, receive, from a user terminal, a prompt sentence input by a user, and analyze the prompt sentence to determine an analysis intent including at least a type of target behavior and an analysis scope, select, based on the analysis intent, at least part of the feature information and an output of the prediction information processing model as analysis targets, and generate structured information including identifiers of analysis targets, corresponding feature information, and corresponding model outputs,
generate, based on the prompt sentence and the structured information, an input sentence for a generative information processing model, the input sentence instructing the generative information processing model to perform explanation or advice generation regarding the analysis targets,
input the input sentence to the generative information processing model and acquire a generation result including at least one of an explanatory text and advisory information related to the behavior relevance of the analysis targets, and output, to the user terminal, an analysis result including the generation result and the feature information associated with the analysis targets.

### Supplementary 2

The system according to supplementary 1,
wherein the processor is configured to
generate, based on the generation result including the explanatory text or the advisory information and on the degree of relevance indicated by the feature information, alert information to be presented prior to transmission of specific information to an external destination, and output the alert information to the user terminal.

### Supplementary 3

The system according to supplementary 1,
wherein the processor is configured to
identify, based on the feature information and the explanatory text included in the generation result, information related to behaviors including at least fraudulent conduct or harmful conduct, and output, to the user terminal, identifiers corresponding to the identified information and degrees of relevance associated with the identified information.

### Application Example 1

### Supplementary 1

A system comprising a processor,
wherein the processor is configured to
receive communication information obtained from a terminal apparatus via a communication device, normalize and structure the communication information as character information, and convert the communication information into a numerical representation by using a natural language processing technique,
construct an instruction sentence based on the numerical representation for input to a generative learning model, input the instruction sentence as a prompt sentence into the generative learning model, and obtain, from the generative learning model, risk evaluation information and explanation information indicating whether the communication information is related to a criminal act,
determine, based on the risk evaluation information, an evaluation value and a category indicating a degree of danger of the communication information, and generate warning information and communication restriction information according to the evaluation value and the category,
transmit notification information including the warning information and the communication restriction information to the terminal apparatus, and control a display form or an operation permission state of the communication information on the terminal apparatus, and record the communication information, the risk evaluation information, the evaluation value, and the category as history information in a storage device, and use the history information for learning or parameter updating of the generative learning model.

### Supplementary 2

The system according to supplementary 1,
wherein the processor is configured to
control a user interface on the terminal apparatus so as to prohibit or restrict a selection operation of reference information included in the communication information by using the notification information, and additionally record operation information from a user in the storage device as the history information so that the operation information is usable as teacher information for learning of the generative learning model.

### Supplementary 3

The system according to supplementary 1,
wherein the processor is configured to
input an inquiry sentence received from a user as a prompt sentence into the generative learning model, obtain, from the generative learning model, risk explanation information regarding a criminal act for communication information or identification information included in the inquiry sentence, and transmit the risk explanation information to the terminal apparatus for display so as to present advice to the user regarding a danger of the communication information.

### Example 2

### Supplementary 1

A system comprising a processor,
wherein the processor is configured to
receive, via a communication apparatus, a message to be transmitted that is input by a user through an input apparatus,
perform preprocessing on the message to be transmitted, the preprocessing including unifying character types, deleting unnecessary characters, and normalizing a format of the message to be transmitted, and convert the preprocessed message to be transmitted into text data that is processable by a generative information processing model,
generate a prompt sentence including the preprocessed text data and input the prompt sentence to the generative information processing model, obtain, by using a computing apparatus and the generative information processing model, evaluation information indicating a possibility that the message to be transmitted is related to criminal activity, based on the prompt sentence,
determine a risk level for the message to be transmitted based on the evaluation information, and generate alert information when the risk level satisfies a predetermined condition, and transmit, via the communication apparatus, notification information including the alert information, associated with the message to be transmitted, to the input apparatus for display.

### Supplementary 2

The system according to supplementary 1,
wherein the processor is configured to
extract the evaluation information from response text output by the generative information processing model, the response text including at least one of a classification result and a probability value, and obtain the evaluation information by parsing the response text for predetermined keywords or structured data.

### Supplementary 3

The system according to supplementary 1,
wherein the processor is configured to
generate the prompt sentence in a structure including a command sentence that instructs the generative information processing model to determine whether the message to be transmitted is information related to criminal or improper activity, and constraint conditions that instruct the generative information processing model to output a determination result and a reason for the determination in a predetermined format, and input the prompt sentence to the generative information processing model.

### Application Example 2

### Supplementary 1

A system comprising a processor,
wherein the processor is configured to
acquire, from a storage device, information related to past events associated with crime, perform preprocessing on the information by using a natural language processing technique, and convert the information into numerical vectors,
generate, based on the numerical vectors and classification information indicating crime-related or non-crime-related labels, a trained information processing model including a generative AI model by using a machine learning algorithm, and store the trained information processing model in a storage device,
receive input information including communication content from a terminal device, perform preprocessing on the input information by using the natural language processing technique, generate a prompt including a prompt sentence that defines processing for causing the generative AI model to extract features related to crime from the input information, input the prompt to the generative AI model, and obtain an analysis result regarding crime relevance of the input information from the generative AI model,
calculate a risk index for the input information based on the analysis result, compare the risk index with a predetermined threshold, determine at least one of permission of continuation of communication, restriction of transmission of the communication, and blocking of transmission of the communication according to a comparison result, and notify the terminal device of a determination result,
estimate an emotional state of the input information or of a user associated with the input information by using an emotion analysis technique, and adjust at least one of expression content and presentation timing of a warning to be presented to the user based on the emotional state and the risk index,
when the risk index is equal to or higher than a predetermined high level, encrypt notification information including summary information regarding the input information and the risk index and transmit the notification information to an external public organization, and
accumulate, for each user, history information regarding the emotional state and the risk index, and generate control information for updating at least one of future presentation timing and warning intensity of the warning based on a time-series change pattern of the history information.

### Supplementary 2

The system according to supplementary 1,
wherein the processor is configured to cause the terminal device to display warning information on a transmission operation screen for the user based on the risk index and the warning notified from the system, and to cause the terminal device to perform control for stopping a transmission process of the communication content when blocking of the transmission is instructed from the system.

### Supplementary 3

The system according to supplementary 1,
wherein the processor is configured to include, in the prompt input to the generative AI model, a description that instructs the generative AI model to perform, in addition to extraction of features related to crime from the input information, estimation of an emotional state inherent in the input information and output of explanatory information regarding crime relevance, obtain, from the generative AI model, the risk index represented as a numerical value and the explanatory information represented in a natural language at the same time, and include the explanatory information in the warning to be notified to the terminal device.

What is claimed is:

1. A system comprising:
circuitry configured to
retrieve, from a storage device, a plurality of historical text data records and associated classification label data;
apply a preprocessing operation to each historical text data record, the preprocessing operation comprising character normalization, removal of non-semantic tokens, and segmentation into linguistic unit sequences, and convert each preprocessed linguistic unit sequence into a numerical feature vector by applying an embedding operation using a natural language processing model;
train, using a machine learning framework, a prediction information processing model based on the numerical feature vectors and the associated classification label data, the training comprising iteratively updating parameter values of the prediction information processing model to reduce a loss function value;
receive, via a packet-switched network, new text data from a terminal device, apply the preprocessing operation and the embedding operation to the new text data to generate a new numerical feature vector, and input the new numerical feature vector to the prediction information processing model to obtain feature information comprising relevance score data indicating a degree of association between the new text data and each classification label;
receive, via the packet-switched network, a prompt character sequence from the terminal device, and analyze the prompt character sequence to determine an analysis intent comprising at least a target classification type and an analysis scope parameter;
select, based on the analysis intent, at least a portion of the feature information and output data of the prediction information processing model as analysis target data, and generate structured information data encoding identifiers, corresponding relevance score data, and representative text segments for the analysis target data;
generate a structured input sequence for a generative neural network model based on the prompt character sequence and the structured information data, the structured input sequence comprising an instruction portion and a context data portion;
input the structured input sequence to the generative neural network model to obtain output character sequence data comprising inference data generated by the generative neural network model; and
transmit, via the packet-switched network, an analysis result comprising the output character sequence data and the feature information to the terminal device for rendering on a display of the terminal device.

2. The system according to claim 1, wherein the embedding operation comprises mapping each linguistic unit to an integer index using a vocabulary data structure and transforming each integer index into a multidimensional real-valued vector using an embedding matrix, and wherein the numerical feature vector comprises a tensor representation having a sequence length dimension and an embedding dimension.

3. The system according to claim 2, wherein the prediction information processing model comprises a feed-forward neural network having an input layer corresponding to the embedding dimension, one or more hidden layers with non-linear activation functions, and an output layer that generates a probability distribution over the classification labels, and wherein the loss function comprises a cross-entropy loss computed between predicted probability values and ground-truth classification label values.

4. The system according to claim 3, wherein the plurality of historical text data records comprise behavior-related text records associated with historical events, and wherein the classification label data comprises labels distinguishing crime-related records from non-crime-related records, and wherein the relevance score data indicates a degree of association between the new text data and at least one of fraudulent conduct and harmful conduct.

5. The system according to claim 4, wherein the analysis intent further specifies a temporal scope parameter defining a time window for filtering the analysis target data, and wherein the structured information data further encodes aggregated metrics comprising a maximum relevance score value and a mean relevance score value computed per entity identifier over the temporal scope parameter.

6. The system according to claim 1, wherein the generative neural network model comprises a transformer-based language model having an embedding layer that maps input token identifiers to multidimensional vector representations, a plurality of self-attention layers that compute attention weight distributions over the vector representations, and a feed-forward output layer that generates a probability distribution over a vocabulary of token identifiers.

7. The system according to claim 6, wherein the structured input sequence further encodes a constraint specification portion that instructs the generative neural network model to produce the output character sequence data in a predetermined structured format comprising labeled fields for a classification result and an explanatory text segment.

8. The system according to claim 7, wherein the circuitry is further configured to parse the output character sequence data by detecting predetermined delimiter tokens or keyword markers specified in the constraint specification portion, and extract a classification result value and an explanatory text string from the output character sequence data based on the detected delimiter tokens.

9. The system according to claim 8, wherein the circuitry is further configured to compute a risk index value based on the classification result value extracted from the output character sequence data, compare the risk index value with a predetermined threshold value stored in the storage device, and generate alert information data when the risk index value exceeds the predetermined threshold value.

10. The system according to claim 1, wherein the circuitry is further configured to:
receive, via the packet-switched network, communication content data from the terminal device prior to transmission of the communication content data to a destination address;
apply the preprocessing operation and the embedding operation to the communication content data to generate a communication feature vector;
generate a second structured input sequence for the generative neural network model encoding the communication content data and an instruction character sequence specifying evaluation of the communication content data; and
input the second structured input sequence to the generative neural network model to obtain evaluation output data comprising a risk evaluation result and an explanation character sequence.

11. The system according to claim 10, wherein the circuitry is further configured to compute a risk level value based on the risk evaluation result, and determine, based on the risk level value and one or more threshold values, a transmission control action comprising one of permitting transmission of the communication content data, generating a warning notification prior to transmission, or blocking transmission of the communication content data.

12. The system according to claim 11, wherein the circuitry is further configured to transmit, via the packet-switched network, notification information comprising warning text data and communication restriction data to the terminal device, and wherein the communication restriction data specifies at least one operation permission state modification for controlling an interactive element associated with the communication content data on the terminal device.

13. The system according to claim 1, wherein the circuitry is further configured to:
apply an affective state estimation model to the new text data to determine an affective state indicator comprising a dominant affective category label and an associated confidence score value; and
adjust at least one of an expression content parameter and a presentation timing parameter of a notification to be transmitted to the terminal device based on the affective state indicator and the relevance score data.

14. The system according to claim 13, wherein the affective state estimation model comprises a neural network classifier that receives the new numerical feature vector and outputs a probability distribution over a plurality of affective category labels, and wherein the dominant affective category label corresponds to the affective category having a highest probability value in the probability distribution.

15. The system according to claim 1, wherein the circuitry is further configured to:
record, in the storage device, history data comprising the new text data, the feature information, the output character sequence data, and a user operation indicator received from the terminal device; and
use the history data to update parameter values of at least one of the prediction information processing model and the generative neural network model by computing a training loss based on the user operation indicator as supervision data.

16. The system according to claim 15, wherein the user operation indicator comprises at least one of a confirmation action, a dismissal action, and a reporting action performed by a user at the terminal device in response to the analysis result, and wherein the circuitry uses the user operation indicator as teacher data for fine-tuning the prediction information processing model.

17. The system according to claim 16, wherein the circuitry is further configured to accumulate, for each entity identifier, time-series history data comprising affective state indicators and relevance score values over a plurality of temporal periods, and generate control parameter data for adjusting at least one of a notification threshold value and a warning intensity level based on a temporal pattern detected in the time-series history data.

18. A system comprising:
circuitry configured to
retrieve, from a storage device, historical text data records and associated classification label data, apply a preprocessing operation comprising character normalization, token removal, and segmentation to the historical text data records, and convert the preprocessed text data into numerical feature vectors using an embedding operation;
train a prediction information processing model using the numerical feature vectors and the classification label data by iteratively updating model parameters to minimize a loss function;
receive, via a packet-switched network, communication content data from a terminal device, apply the preprocessing operation and the embedding operation to the communication content data to generate a communication feature vector, and input the communication feature vector to the prediction information processing model to obtain relevance score data;
generate a structured input sequence for a generative neural network model encoding the communication content data and an instruction character sequence comprising a task definition portion and a constraint specification portion that specifies a predetermined output format;
input the structured input sequence to the generative neural network model to obtain output character sequence data, and parse the output character sequence data according to the predetermined output format to extract a risk evaluation result and an explanation character sequence;
compute a risk level value based on the risk evaluation result, determine a transmission control action based on comparison of the risk level value with threshold values, and generate notification information comprising warning text data and a transmission control directive;
apply an affective state estimation model to the communication content data to determine an affective state indicator, and adjust a presentation parameter of the notification information based on the affective state indicator;
transmit, via the packet-switched network, the notification information and the transmission control directive to the terminal device for rendering on a display of the terminal device; and
record history data comprising the communication content data, the relevance score data, the risk level value, the affective state indicator, and a user operation indicator in the storage device for use in updating parameter values of at least one of the prediction information processing model and the generative neural network model.

19. The system according to claim 18, wherein the circuitry is further configured to, when the risk level value exceeds a critical threshold value, encrypt notification data comprising a summary of the communication content data and the risk level value, and transmit the encrypted notification data to an external system interface address via the packet-switched network.

20. A method comprising:
retrieving, from a storage device, a plurality of historical text data records and associated classification label data;
applying a preprocessing operation to each historical text data record, the preprocessing operation comprising character normalization, removal of non-semantic tokens, and segmentation into linguistic unit sequences, and converting each preprocessed linguistic unit sequence into a numerical feature vector by applying an embedding operation using a natural language processing model;
training, using a machine learning framework, a prediction information processing model based on the numerical feature vectors and the associated classification label data, the training comprising iteratively updating parameter values of the prediction information processing model to reduce a loss function value;
receiving, via a packet-switched network, new text data from a terminal device, applying the preprocessing operation and the embedding operation to the new text data to generate a new numerical feature vector, and inputting the new numerical feature vector to the prediction information processing model to obtain feature information comprising relevance score data indicating a degree of association between the new text data and each classification label;
receiving, via the packet-switched network, a prompt character sequence from the terminal device, and analyzing the prompt character sequence to determine an analysis intent comprising at least a target classification type and an analysis scope parameter;
selecting, based on the analysis intent, at least a portion of the feature information and output data of the prediction information processing model as analysis target data, and generating structured information data encoding identifiers, corresponding relevance score data, and representative text segments for the analysis target data;
generating a structured input sequence for a generative neural network model based on the prompt character sequence and the structured information data, the structured input sequence comprising an instruction portion and a context data portion;
inputting the structured input sequence to the generative neural network model to obtain output character sequence data comprising inference data generated by the generative neural network model; and
transmitting, via the packet-switched network, an analysis result comprising the output character sequence data and the feature information to a terminal device for rendering on a display of the terminal device.
